(19) United States
(12) Patent Application Publication
(10) Pub. No.: US 2024/0174879 A1
(43) Pub. Date: May 30, 2024

(54) CONDUCTIVE COMPOSITION, METHOD FOR PRODUCING SAME, METHOD FOR RECORDING CONDUCTIVE IMAGE, AND CONDUCTIVE IMAGE

(71) Applicants: CANON KABUSHIKI KAISHA, Tokyo (JP); CANON VIRGINIA INC., Newport News, VA (US)

(72) Inventors: MASANORI SEKI, Kanagawa (JP); TAIKI WATANABE, Tokyo (JP); YUMA KOBAYASHI, Kanagawa (JP); HIROSHI TANABE, Kanagawa (JP)

(21) Appl. No.: 18/405,999

(22) Filed: Jan. 5, 2024

Related U.S. Application Data
(63) Continuation of application No. PCT/JP2022/024057, filed on Jun. 16, 2022.

(30) Foreign Application Priority Data
Jul. 7, 2021 (JP) 2021-113076
Jul. 7, 2021 (JP) 2021-113077
Jul. 7, 2021 (JP) 2021-113078
Jul. 7, 2021 (JP) 2021-113079
Jun. 1, 2022 (JP) 2022-089685

(51) Int. Cl. C09D 11/52; B22F 1/102; B22F 1/145; B22F 9/24; C09C 1/62; C09C 3/08; C09D 11/037; C09D 11/322

(52) U.S. Cl. CPC C09D 11/52; B22F 1/102; B22F 1/145; B22F 9/24; C09C 1/62; C09C 3/08; C09D 11/037; C09D 11/322; B22F 2009/001; C01P 2004/64; C01P 2006/42

(57) ABSTRACT

The conductive composition includes: a metal particle; and a treatment agent for coating the metal particle. The treatment agent is at least one kind selected from the group consisting of: a compound represented by the general formula (1); a compound represented by the general formula (2); a compound represented by the general formula (3); a compound represented by the general formula (4); a compound represented by the general formula (5); a compound represented by the general formula (6); and a compound represented by the general formula (7). The method of producing the conductive composition includes: a first step of reducing a metal salt in an aqueous medium to form the metal particle; and a second step of bringing the formed metal particle into contact with the treatment agent.

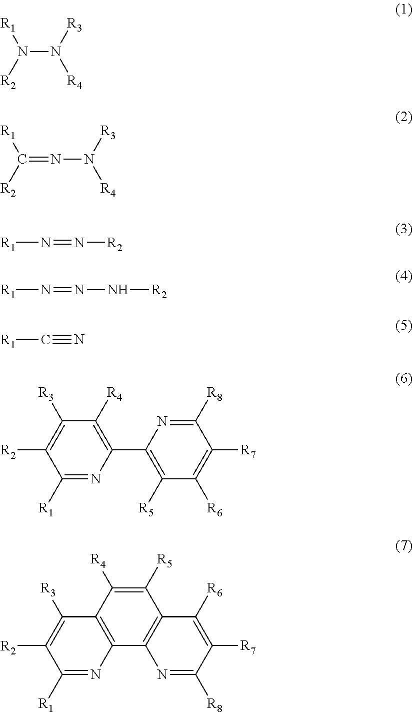

### CROSS-REFERENCE TO RELATED APPLICATIONS

This application is a Continuation of International Patent Application No. PCT/JP2022/024057, filed Jun. 16, 2022, which claims the benefit of Japanese Patent Application No. 2021-113076, filed Jul. 7, 2021, Japanese Patent Application No. 2021-113077, filed July 7, 2021, Japanese Patent Application No. 2021-113078, filed Jul. 7, 2021, Japanese Patent Application No. 2021-113079, filed July 7, 2021, and Japanese Patent Application No. 2022-089685, filed Jun. 1, 2022, all of which are hereby incorporated by reference herein in their entirety.

### BACKGROUND OF THE INVENTION

### Field of the Invention

The present invention relates to a conductive composition and a method of producing the conductive composition, a method of recording a conductive image and a conductive image.

### Description of the Related Art

As a material for recording and forming a film-shaped conductive image, such as a pattern or a circuit that shows conductivity, a liquid conductive composition including a metal particle is used. In order to stably disperse the metal particle in such conductive composition, a modifier that may adsorb to the metal particle needs to be used. However, such modifier is a component that does not contribute to the conductivity, and hence has needed to be removed from a recorded conductive image by being subjected to firing treatment at high temperature or washing treatment using a solvent. However, along with the diversification of a base material on which the conductive image is recorded, a conductive composition for which the firing treatment at high temperature is not needed is required.

For example, in Japanese Patent Application Laid-Open No. 2006-335995, there is a proposal of a conductive ink for forming a conductive pattern containing a conductive particle and an ionic liquid. In addition, in Japanese Patent Application Laid-Open No. 2014-240491, there is a proposal of a conductive ink for forming a conductive coating film containing a metal particle, an organic component that may adsorb to a surface of the metal particle to form a micelle structure and an amine compound that acts as a stabilizer. Further, in Japanese Patent Application Laid-Open No. 2016-026237, there is a proposal of a nanoink composition for forming a conductive film containing a metal particle and an organic π-conjugated ligand such as phthalocyanine that forms a π-bonding to the metal particle. In addition, in Japanese Patent Application Laid-Open No. 2015-076233, there is a proposal of a conductive paste for superheated steam treatment containing a metal particle, a resin binder and a hydrazone compound. In Japanese Patent Application Laid-Open No. 2015-076233, there is a disclosure that, after screen printing of the paste, superheated steam treatment is performed to generate a hydrazine compound having a reducing property from the hydrazone compound, to thereby reduce a metal oxide to a metal.

However, a component that does not contribute to the conductivity cannot be sufficiently removed by only performing simple posttreatment such as drying without performing firing at high temperature after the conductive ink or the like proposed in Japanese Patent Application Laid-Open No. 2006-335995, Japanese Patent Application Laid-Open No. 2014-240491, Japanese Patent Application Laid-Open No. 2016-026237 or Japanese Patent Application Laid-Open No. 2015-076233 is applied to a base material, and hence it has been difficult to record an image excellent in conductivity.

### SUMMARY OF THE INVENTION

Accordingly, an object of the present invention is to provide a conductive composition with which a conductive image excellent in conductivity can be easily recorded by only performing simple posttreatment. Another object of the present invention is to provide a method of producing the conductive composition, a method of recording a conductive image using the conductive composition and a conductive image.

That is, according to the present invention, there is provided a conductive composition including: a metal particle; and a treatment agent for coating the metal particle, wherein the treatment agent is at least one kind selected from the group consisting of: a compound represented by the following general formula (1); a compound represented by the following general formula (2); a compound represented by the following general formula (3); a compound represented by the following general formula (4); a compound represented by the following general formula (5); a compound represented by the following general formula (6); and a compound represented by the following general formula (7):

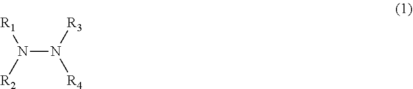

in the general formula (1), R₁ to R₄ each independently represent a hydrogen atom, an aliphatic group, an aromatic group, an acid ester group or a hydrophilic group, at least one of R₁ to R₄ represents the hydrophilic group, not all of the rest of R₁ to R₄ simultaneously represent hydrogen atoms and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond;

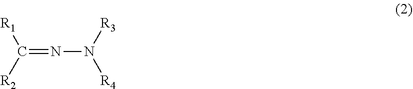

in the general formula (2), R₁ to R₄ each independently represent a hydrogen atom, an aliphatic group, an aromatic group, an acid ester group or a hydrophilic group, at least one of R₁ to R₄ represents the hydrophilic group, not all of the rest of R₁ to R₄ simultaneously represent hydrogen atoms and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond;

R₁—N═N—R₂ (3)

in the general formula (3), R₁ to R₂ each independently represent an aromatic group or a hydrophilic group, at least one of R₁ to R₂ represents the hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond;

R₁—N═N—NH—R₂ (4)

in the general formula (4), R₁ to R₂ each independently represent an aromatic group or a hydrophilic group, at least one of R₁ to R₂ represents the hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond;

R₁—CN (5)

in the general formula (5), R₁ represents a hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond;

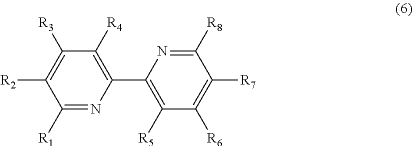

in the general formula (6), R₁ to R₈ each independently represent a hydrogen atom, an aliphatic group, an aromatic group, an acid ester group or a hydrophilic group, at least one of R₁ to R₈ represents the hydrophilic group and the hydrophilic group is: (i) any hydrophilic functional group selected from the group consisting of: a hydroxy group; a carboxylic acid group; a sulfonic acid group; a phosphoric acid group; a phosphonic acid group; a tertiary alkylamino group; and a heteroaromatic group; or (ii) an aliphatic group to which the hydrophilic functional group is bonded and which may have a heteroatom, an amide bond or an ester bond; and

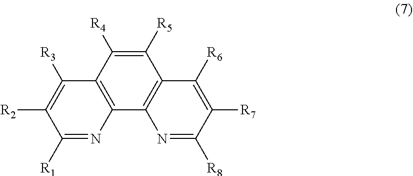

in the general formula (7), R₁ to R₈ each independently represent a hydrogen atom, an aliphatic group, an aromatic group, an acid ester group or a hydrophilic group, at least one of R₁ to R₈ represents the hydrophilic group and the hydrophilic group is: (i) any hydrophilic functional group selected from the group consisting of: a hydroxy group; a carboxylic acid group; a sulfonic acid group; a phosphoric acid group; a phosphonic acid group; a tertiary alkylamino group; and a heteroaromatic group; or (ii) an aliphatic group to which the hydrophilic functional group is bonded and which may have a heteroatom, an amide bond or an ester bond.

Further features of the present invention will become apparent from the following description of exemplary embodiments.

### DESCRIPTION OF THE EMBODIMENTS

The present invention is described in more detail below by way of exemplary embodiments. In the present invention, when a compound is a salt, the salt is present as dissociated ions in a composition, but the expression “contain a salt” is used for convenience. In the present invention, a conductive composition is sometimes simply referred to as “composition” or “ink”. In addition, the “image” in the present invention encompasses, for example, a letter, a photograph, a line drawing, a wiring and a pattern and the “recording” or “forming” refers to expressing a desired “image” on a base material. Physical property values are values at normal temperature (25° C.), unless otherwise stated.

The inventors of the present invention have made various investigations, and as a result, have found that it is effective to use a low-molecular weight compound having a hydrazine structure that functions as a moiety that adsorbs to a metal particle and a hydrophilic group for dispersing the metal particle as a modifier of the metal particle. That is, the inventors have found that when a metal particle and a specific low-molecular weight compound having a hydrazine structure and a hydrophilic group are used in combination, a conductive image excellent in conductivity can be recorded by only performing simple posttreatment such as drying. Thus, the inventors have reached the present invention.

### Conductive Composition

A conductive composition of the present invention contains a metal particle and a treatment agent for coating the metal particle. The respective components for forming the conductive composition are described below.

### (Metal Particle)

The conductive composition contains a metal particle. The metal particle is preferably formed of at least one kind of metal selected from the group consisting of: nickel; palladium; platinum; copper; silver; and gold. The metal for forming the metal particle is preferably platinum, copper, silver or gold, particularly preferably silver or gold out of those metals.

At least part of a particle surface of the metal particle is coated with a treatment agent to be described below. When the treatment agent interacts with the metal particle, the treatment agent adheres to a surface of the metal particle to be immobilized. The interaction between the metal particle and the treatment agent includes physical adsorption and chemical adsorption. In the case of the physical adsorption, van der Waals interaction and ion adsorption are present in a mixed manner and are considered to be in an equilibrium state. Meanwhile, in the case of the chemical adsorption, it is considered that a metal atom in the metal particle and a nitrogen atom in the treatment agent form a chemical bond (covalent bond). The coating of the metal particle with the treatment agent may be any of the physical adsorption and the chemical adsorption.

In each of compounds to be used as the treatment agent of the metal particle to be described below, it is considered that a nitrogen atom interacts with the metal particle to cause the compound to coat the metal particle, and at the same time, a hydrophilic group functions as a dispersion group for dispersing the metal particle. When such specific low-molecular weight compound is used, the metal particle, which has been difficult to be dispersed in a liquid medium such as an aqueous medium, can be stably dispersed. In addition to the foregoing, a conductive composition that can easily form a conductive image excellent in conductivity by only performing simple posttreatment such as drying can be achieved.

Whether at least part of the surface of the metal particle is coated with the treatment agent may be recognized by a zeta potential of the metal particle. A metal particle not coated with the treatment agent typically has a zeta (0 potential of 0 mV or more. That is, the zeta potential shows zero or a plus value having a small absolute value (value of from about 0 mV to about +3 mV). In contrast, the zeta potential of the metal particle in which at least part of its particle surface is coated with the treatment agent changes in accordance with the hydrophilic group of the treatment agent. When the hydrophilic group of the treatment agent is anionic, the zeta potential of the metal particle coated with the treatment agent shows a value (mainly a minus value, specifically a value of -1 mV or less) lower than the zeta potential of the metal particle not coated therewith. Meanwhile, when the hydrophilic group of the treatment agent is a heteroaromatic group or a tertiary alkylamino group, the zeta potential of the metal particle coated with the treatment agent shows a value (mainly a plus value having a large absolute value, specifically a value of +5 mV or more) higher than the zeta potential of the metal particle not coated therewith.

The zeta potential may be measured with a zeta potential measurement apparatus. In the measurement of the zeta potential, in order to remove the treatment agent that does not coat the metal particle, it is preferred to use a sample prepared by subjecting the conductive composition to centrifugation treatment and removing the supernatant to provide a wet cake and then diluting the wet cake with a liquid medium (e.g., water).

In the production process for the conductive composition, whether at least part of the surface of the metal particle is coated with the treatment agent may also be recognized by tracking the amount of each of those compounds before and after being brought into contact with the metal particle. Whether part or all of the surface of the metal particle is coated with the treatment agent may be verified by, for example, after bringing the metal particle and the treatment agent into contact with each other, subjecting the resultant to centrifugation to perform solid-liquid separation and then subjecting the treatment agent in the supernatant to be obtained to quantitative analysis. As a method (analysis method) of tracking the amount of the treatment agent before and after being brought into contact with the metal particle, there may be given, for example, a method using a high-performance liquid chromatograph (HPLC) or a gas chromatograph (GC).

The metal particle is present in the conductive composition in a dispersed state. The volume-based 50% cumulative particle diameter of the metal particle in the conductive composition is preferably 5 nm or more to 100 nm or less from the viewpoint of storage stability. The “volume-based 50% cumulative particle diameter” is hereinafter also simply referred to as “average particle diameter”. When the average particle diameter of the metal particle is less than 5 nm, the metal particles may be liable to aggregate in the conductive composition. Meanwhile, when the average particle diameter of the metal particle is more than 100 nm, the metal particle may be liable to precipitate in the conductive composition. The volume-based 50% cumulative particle diameter (average particle diameter) of the metal particle may be measured by a dynamic light scattering method. When the metal particle is formed of gold or silver, a difference in particle diameter of the metal particle can be simply judged by measuring an ultraviolet-visible absorption spectrum.

### (Treatment Agent)

The conductive composition contains at least one kind selected from the group consisting of the compounds represented by the following general formulae (1) to (7) as the treatment agent for coating the metal particle. The treatment agent is preferably a colorless compound (compound having no absorption maximum in the wavelength region of from 360 nm to 830 nm). That is, the treatment agent is free from being a so-called “coloring material”. The treatment agent has a molecular weight of preferably 1,000 or less, more preferably 600 or less, particularly preferably 500 or less and of preferably 100 or more. The molecular weight of the treatment agent is based on the structures in which an anionic group is set to an acid form and a cationic group is set to a base form.

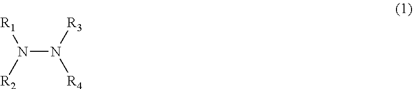

In the general formula (1), R₁ to R₄ each independently represent a hydrogen atom, an aliphatic group, an aromatic group, an acid ester group or a hydrophilic group, at least one of R₁ to R₄ represents the hydrophilic group, not all of the rest of R₁ to R₄ simultaneously represent hydrogen atoms and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond. The compound represented by the general formula (1) may also be referred to as “hydrazine compound”.

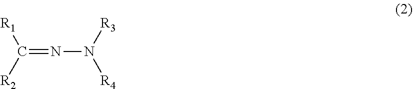

In the general formula (2), R₁ to R₄ each independently represent a hydrogen atom, an aliphatic group, an aromatic group, an acid ester group or a hydrophilic group, at least one of R₁ to R₄ represents the hydrophilic group, not all of the rest of R₁ to R₄ simultaneously represent hydrogen atoms and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond. The compound represented by the general formula (2) may also be referred to as “hydrazone compound”.

R₁—N═N—R₂ (3)

In the general formula (3), R₁ to R₂ each independently represent an aromatic group or a hydrophilic group, at least one of R₁ to R₂ represents the hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond.

R₁—N═N—NH—R₂ (4)

In the general formula (4), R₁ to R₂ each independently represent an aromatic group or a hydrophilic group, at least one of R₁ to R₂ represents the hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond.

R₁—CN (5)

In the general formula (5), R₁ represents a hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond.

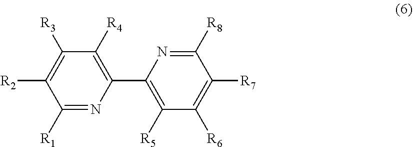

In the general formula (6), R₁ to R₈ each independently represent a hydrogen atom, an aliphatic group, an aromatic group, an acid ester group or a hydrophilic group, at least one of R₁ to R₈ represents the hydrophilic group and the hydrophilic group is: (i) any hydrophilic functional group selected from the group consisting of: a hydroxy group; a carboxylic acid group; a sulfonic acid group; a phosphoric acid group; a phosphonic acid group; a tertiary alkylamino group; and a heteroaromatic group; or (ii) an aliphatic group to which the hydrophilic functional group is bonded and which may have a heteroatom, an amide bond or an ester bond.

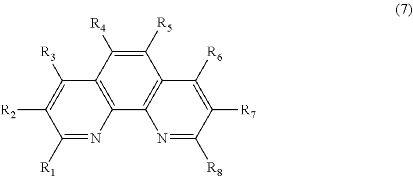

In the general formula (7), R₁ to R₈ each independently represent a hydrogen atom, an aliphatic group, an aromatic group, an acid ester group or a hydrophilic group, at least one of R₁ to R₈ represents the hydrophilic group and the hydrophilic group is: (i) any hydrophilic functional group selected from the group consisting of: a hydroxy group; a carboxylic acid group; a sulfonic acid group; a phosphoric acid group; a phosphonic acid group; a tertiary alkylamino group; and a heteroaromatic group; or (ii) an aliphatic group to which the hydrophilic functional group is bonded and which may have a heteroatom, an amide bond or an ester bond.

Examples of the aliphatic group represented by each of R₁ to R₄ in the general formula (1), R₁ to R₄ in the general formula (2), R₁ to R₈ in the general formula (6) and R₁ to R₈ in the general formula (7) may include an alkyl group and an alkenyl group. The alkyl group and the alkenyl group may each be linear, branched or cyclic, and each preferably have 1 to 12 carbon atoms. Examples of the alkyl group may include a methyl group, an ethyl group, a propyl group, an isopropyl group, a butyl group, an isobutyl group, a s-butyl group, a t-butyl group, a pentyl group, an isopentyl group, a s-pentyl group, a t-pentyl group, a neopentyl group, a hexyl group, a cyclopentyl group and a cyclohexyl group. Examples of the alkenyl group may include an ethenyl group, a propenyl group and a butenyl group. At least some of the hydrogen atoms for forming the aliphatic group may each be substituted with: a halogen atom, such as a fluorine atom, a chlorine atom or a bromine atom; or a heteroatom, such as a nitrogen atom, an oxygen atom or a sulfur atom.

Examples of the aromatic group represented by each of R₁ to R₄ in the general formula (1), R₁ to R₄ in the general formula (2), R₁ to R₂ in the general formula (3), R₁ to R₂ in the general formula (4), R₁ to R₈ in the general formula (6) and R₁ to R₈ in the general formula (7) may include an aryl group and a heteroaryl group. The aryl group and the heteroaryl group may each be monocyclic or heterocyclic, and each preferably have 3 to 10 ring-forming atoms. Examples of the heteroatom for forming the heteroaryl group may include a nitrogen atom, an oxygen atom and a sulfur atom. Examples of the aryl group may include a phenyl group, a naphthyl group, an anthracenyl group, a phenanthrenyl group and a biphenyl group. Examples of the heteroaryl group may include a pyridyl group, an imidazolyl group, a pyrazolyl group, a pyridinyl group, a thienyl group and a thiazolyl group. Of those, a phenyl group, a naphthyl group, an anthracenyl group, a phenanthrenyl group, a biphenyl group and a pyridinyl group are preferred, and a phenyl group is more preferred.

The acid ester group represented by each of R₁ to R₄ in the general formula (1), R₁ to R₄ in the general formula (2), R₁ to R₈ in the general formula (6) and R₁ to R₈ in the general formula (7) is a group obtained by bonding the aliphatic group or aromatic group described above to an ester bond —C(═O)—O— of a carboxylic acid. Examples of the acid ester group may include a methoxycarbonyl group, an ethoxycarbonyl group, a n-propoxycarbonyl group, an i-propoxycarbonyl group, a n-butoxycarbonyl group, a t-butoxycarbonyl group and a phenoxycarbonyl group.

At least one of R₁ to R₄ in the general formula (1) represents a hydrophilic group, and not all of the rest of R₁ to R₄ simultaneously represent hydrogen atoms. At least one of R₁ to R₄ in the general formula (2) represents a hydrophilic group, and not all of the rest of R₁ to R₄ simultaneously represent hydrogen atoms. When not all of the groups of R₁ to R₄ in the general formula (1) and R₁ to R₄ in the general formula (2) except a hydrophilic group represent hydrogen atoms and at least one of these groups has a structure having a substituent except a hydrophilic group, reactivity of the hydrazine structure serving as a reaction active site can be reduced. Thus, aggregation of the metal particles by reduction can be suppressed. In addition, at least one of R₁ to R₂ in the general formula (3) represents a hydrophilic group. At least one of R₁ to R₂ in the general formula (4) represents a hydrophilic group. R₁ in the general formula (5) represents a hydrophilic group.

The hydrophilic group represented by each of R₁ to R₄ in the general formula (1), R₁ to R₄ in the general formula (2), R₁ to R₂ in the general formula (3), R₁ to R₂ in the general formula (4) and R₁ in the general formula (5) is any one of the following (i) to (iii):
(i) a heteroaromatic group;
(ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; and
(iii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded via an aliphatic group that may have a heteroatom, an amide bond or an ester bond.

Examples of the heteroatom for forming (i) the heteroaromatic group may include a nitrogen atom, an oxygen atom and a sulfur atom. Examples of the heteroaromatic group may include a pyridyl group, a pyridazyl group, a pyrazyl group, a pyrimidyl group, a triazyl group, an imidazolyl group, a pyrazolyl group, a pyridinyl group, a thienyl group, a thiazolyl group and a furanyl group. Of those, a pyridazyl group, a pyrazyl group, a pyrimidyl group and a triazyl group are preferred. That is, the hydrophilic group in the general formula (1) and the hydrophilic group in the general formula (2) are preferably each independently (i) any heteroaromatic group selected from the group consisting of: a pyridazyl group; a pyrazyl group; a pyrimidyl group; and a triazyl group.

Examples of (ii) the aromatic group to which a hydrophilic functional group such as a hydroxy group is bonded may include an aryl group and a heteroaryl group. The aryl group and the heteroaryl group may each be monocyclic or heterocyclic, and each preferably have 3 to 10 ring-forming atoms. Examples of the heteroatom for forming the heteroaryl group may include a nitrogen atom, an oxygen atom and a sulfur atom. Examples of the aryl group may include a phenyl group, a naphthyl group, an anthracenyl group, a phenanthrenyl group and a biphenyl group. Examples of the heteroaryl group may include a pyridyl group, an imidazolyl group, a pyrazolyl group, a pyridinyl group, a thienyl group and a thiazolyl group. Of those, a phenyl group, a naphthyl group, an anthracenyl group, a phenanthrenyl group, a biphenyl group and a pyridinyl group are preferred, and a phenyl group is more preferred.

Examples of (iii) the aromatic group to which a hydrophilic functional group such as a hydroxy group is bonded via an aliphatic group that may have a heteroatom, an amide bond or an ester bond may include an aryl group and a heteroaryl group. The aryl group and the heteroaryl group may each be monocyclic or heterocyclic, and each preferably have 3 to 10 ring-forming atoms. Examples of the heteroatom for forming the heteroaryl group may include a nitrogen atom, an oxygen atom and a sulfur atom. Examples of the aryl group may include a phenyl group, a naphthyl group, an anthracenyl group, a phenanthrenyl group and a biphenyl group. Examples of the heteroaryl group may include a pyridyl group, an imidazolyl group, a pyrazolyl group, a pyridinyl group, a thienyl group and a thiazolyl group. Of those, a phenyl group, a naphthyl group, an anthracenyl group, a phenanthrenyl group, a biphenyl group and a pyridinyl group are preferred, and a phenyl group is more preferred. Examples of the aliphatic group may include alkylene groups each having 1 to 6 carbon atoms, such as a methylene group, an ethylene group, a n-propylene group, an i-propylene group, a butylene group, a propylene group and a hexylene group. Examples of the heteroatom may include a nitrogen atom, an oxygen atom and a sulfur atom.

The hydrophilic groups in the general formulae (1) to (5) are preferably each independently the following group (ii) or (iii). That is, the hydrophilic groups are each preferably: (ii) a phenyl group to which the hydrophilic functional group is bonded; or (iii) a phenyl group to which the hydrophilic functional group is bonded via an aliphatic group that may have a heteroatom, an amide bond or an ester bond. Further, the hydrophilic groups are each preferably a phenyl group to which at least one of a carboxylic acid group and a sulfonic acid group is bonded. In addition, the total number of the carboxylic acid groups and the sulfonic acid groups bonded to the phenyl group is preferably 2 or 3 from the viewpoints of, for example, the hydrophilicity and the ease of availability.

At least one of R₁ to R₈ in the general formula (6) represents a hydrophilic group. At least one of R₁ to R₈ in the general formula (7) represents a hydrophilic group. The hydrophilic group represented by each of R₁ to R₈ in the general formula (6) and Ri to R₈ in the general formula (7) is the following (i) or (ii):
(i) any hydrophilic functional group selected from the group consisting of: a hydroxy group; a carboxylic acid group; a sulfonic acid group; a phosphoric acid group; a phosphonic acid group; a tertiary alkylamino group; and a heteroaromatic group; or
(ii) an aliphatic group to which any hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded and which may have a heteroatom, an amide bond or an ester bond.

Examples of the heteroatom for forming the heteroaromatic group may include a nitrogen atom, an oxygen atom and a sulfur atom. Examples of the heteroaromatic group may include a pyridyl group, a pyridazyl group, a pyrazyl group, a pyrimidyl group, a triazyl group, an imidazolyl group, a pyrazolyl group, a pyridinyl group, a thienyl group, a thiazolyl group and a furanyl group. Of those, a pyridazyl group, a pyrazyl group, a pyrimidyl group and a triazyl group are preferred.

Examples of the aliphatic group may include alkylene groups each having 1 to 6 carbon atoms, such as a methylene group, an ethylene group, a methyl methylene group, a n-propylene group, an i-propylene group, a butylene group, a propylene group and a hexylene group. Examples of the heteroatom may include a nitrogen atom, an oxygen atom and a sulfur atom.

The hydrophilic group in the general formula (6) and the hydrophilic group in the general formula (7) are preferably each independently a group represented by the following general formula (8).

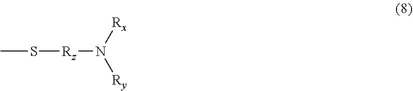

In the general formula (8), Rₓ and R_{y} each independently represent an alkyl group and R_{z} represents an alkylene group. In the general formula (8), the alkyl group represented by each of Rx and R_{y} may be linear, branched or cyclic, and preferably has 1 to 12 carbon atoms. The cyclic alkyl group may be monocyclic or heterocyclic, and preferably has 3 to 10 ring-forming atoms. Examples of the alkyl group may include a methyl group, an ethyl group, a propyl group, an isopropyl group, a butyl group, an isobutyl group, a s-butyl group, a t-butyl group, a pentyl group, an isopentyl group, a s-pentyl group, a t-pentyl group, a neopentyl group, a hexyl group, a cyclopentyl group and a cyclohexyl group.

In the general formula (8), the alkylene group represented by R_{z} may be linear or cyclic, and is preferably an alkylene group having 1 to 6 carbon atoms. Examples of the linear alkylene group may include a methylene group, an ethylene group, a n-propylene group, an i-propylene group, a butylene group, a propylene group and a hexylene group. Examples of the cyclic alkylene group may include a 1,2-cyclobutylene group, a 1,2-cyclopentylene group, a 1,2-cyclohexylene group, a 1,2-cyclooctylene group and a 1,2-cyclodecylene group.

The hydrophilic functional group, such as the hydroxy group, the carboxylic acid group, the sulfonic acid group, the phosphoric acid group, the phosphonic acid group, the tertiary alkylamino group or the heteroaromatic group, in each of the general formulae may form a salt. As a cation for forming a salt, there may be given, for example, an alkali metal ion, an ammonium ion and an organic ammonium ion. Examples of the alkali metal ion may include lithium, sodium and potassium ions. Examples of the organic ammonium ion may include alkylamine and alkanolamine ions. As an anion for forming a salt, there may be given, for example, a hydroxide ion and a halide ion. Examples of the halide ion may include iodine, bromine and chlorine ions.

When the conductive composition further contains an aqueous medium, the hydrophilic group may be selected in accordance with the pH of the aqueous medium. For example, when the pH of the aqueous medium is acidic (pH<7), the tertiary alkylamino group and the heteroaromatic group each easily form a salt. Meanwhile, when the pH of the aqueous medium is alkaline (pH>7), the hydroxy group, the carboxylic acid group, the sulfonic acid group, the phosphoric acid group and the phosphonic acid group each easily form a salt.

Examples of the compound represented by each of the general formulae are shown in Tables 1-1, 1-2, 2-1 to 2-4 and 3 to 7, in which an acidic group is shown as an acid type and a basic group is shown as a base type. Of course, the compound represented by each of the general formulae of the present invention is not limited to the following examples of the compound as long as the compound is included in the structure of each of the general formulae and the definition thereof. In Tables 1-1, 1-2, 2-1 to 2-4 and 3 to 7, the abbreviations “Me”, “Et”, “Ph”, “tBu” and “2Py” represent a methyl group, an ethyl group, a phenyl group, a t-butyl group and a 2-pyridyl group, respectively.

TABLE 1-1
Examples of compound represented by general formula (1)

| Exemplary | | | | |
|---|---|---|---|---|
| compound | R₁ | R₂ | R₃ | R₄ |
| 1-1 | —Me | —Me | —H | 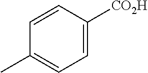 |
| 1-2 | —Me | —Me | —H | 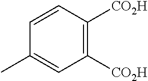 |
| 1-3 | —Me | —Me | —H | 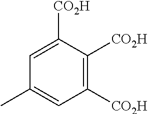 |
| 1-4 | —Me | —Me | —H | 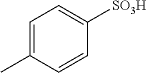 |
| 1-5 | —Me | —Me | —H | 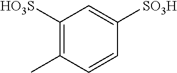 |
| 1-6 | —Me | —Me | —H | 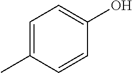 |
| 1-7 | —Me | —Me | —H | 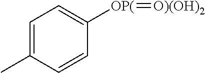 |
| 1-8 | —Me | —Me | —H | 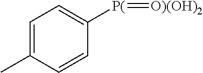 |
| 1-9 | —Me | —Me | —H | 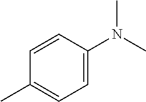 |
| 1-10 | —Me | —Me | —H | 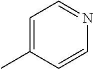 |
| 1-11 | —Me | —Me | —H | 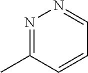 |
| 1-12 | —Me | —Me | —H | 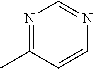 |
| 1-13 | —Me | —Me | —H | 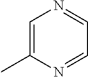 |
| 1-14 | —Me | —Me | —H | 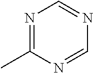 |
| 1-15 | —Me | —Me | —H | 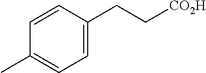 |
| 1-16 | —Me | —Me | —H | 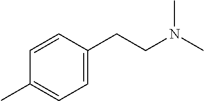 |
| 1-17 | —Me | —Me | —H | 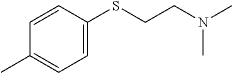 |
| 1-18 | —Me | —Me | —H | 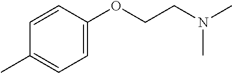 |
| 1-19 | —Me | —Me | —H | 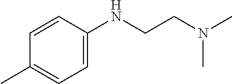 |
| 1-20 | —Me | —Me | —H | 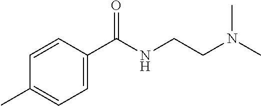 |
| 1-21 | —Me | —Me | —H | 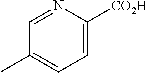 |
| 1-22 | —Me | —Me | —H | 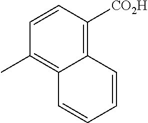 |
| 1-23 | —Me | —Me | —H | 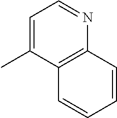 |
| 1-24 | —Me | —H | —H | 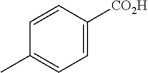 |
| 1-25 | —Me | —H | —H | 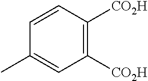 |
| 1-26 | —Me | —H | —H | 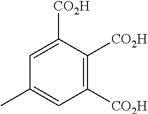 |
| 1-27 | —Me | —H | —H | 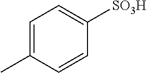 |
| 1-28 | —Me | —H | —H | 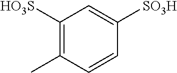 |
| 1-29 | —Me | —H | —H | 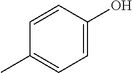 |
| 1-30 | —Me | —H | —H | 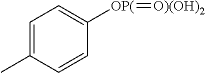 |
| 1-31 | —Me | —H | —H | 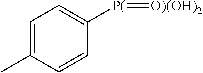 |
| 1-32 | —Me | —H | —H | 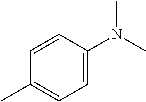 |
| 1-33 | —Me | —H | —H | 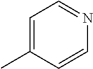 |
| 1-34 | —Me | —H | —H | 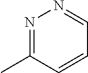 |
| 1-35 | —Me | —H | —H | 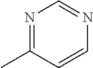 |
| 1-36 | —Me | —H | —H | 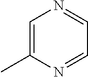 |
| 1-37 | —Me | —H | —H | 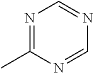 |
| 1-38 | —Me | —H | —H | 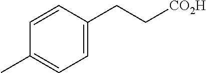 |
| 1-39 | —Me | —H | —H | 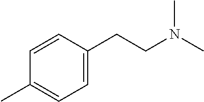 |
| 1-40 | —Me | —H | —H | 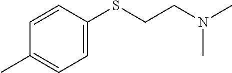 |

TABLE 1-2
Examples of compound represented by general formula (1)

| Exemplary | | | | |
|---|---|---|---|---|
| compound | R₁ | R₂ | R₃ | R₄ |
| 1-41 | —Me | —H | —H | 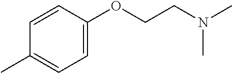 |
| 1-42 | —Me | —H | —H | 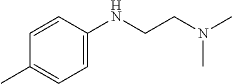 |
| 1-43 | —Me | —H | —H | 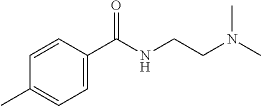 |
| 1-44 | —Me | —H | —H | 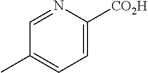 |
| 1-45 | —Me | —H | —H | 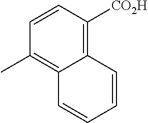 |
| 1-46 | —Me | —H | —H | 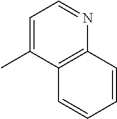 |
| 1-47 | —Ph | —H | —H | 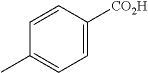 |
| 1-48 | —Ph | —H | —H | 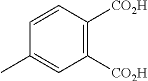 |
| 1-49 | —Ph | —H | —H | 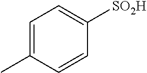 |
| 1-50 | —Ph | —H | —H | 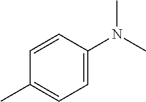 |
| 1-51 | —Ph | —H | —H | 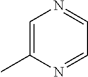 |
| 1-52 | —Ph | —H | —H | 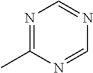 |
| 1-53 | —Ph | —H | —H | 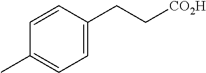 |
| 1-54 | —Ph | —H | —H | 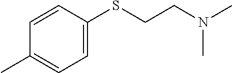 |
| 1-55 | —Ph | —H | —H | 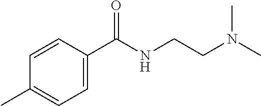 |
| 1-56 | —Ph | —H | —H | 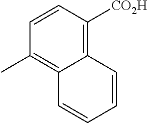 |
| 1-57 | —CO₂tBu | —H | —H | 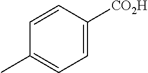 |
| 1-58 | —CO₂tBu | —H | —H | 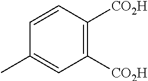 |
| 1-59 | —CO₂tBu | —H | —H | 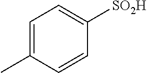 |
| 1-60 | —CO₂tBu | —H | —H | 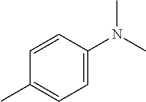 |
| 1-61 | —CO₂tBu | —H | —H | 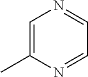 |
| 1-62 | —CO₂tBu | —H | —H | 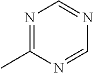 |
| 1-63 | —CO₂tBu | —H | —H | 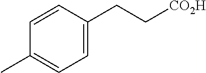 |
| 1-64 | —CO₂tBu | —H | —H | 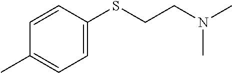 |
| 1-65 | —CO₂tBu | —H | —H | 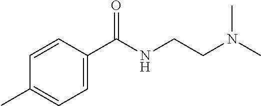 |
| 1-66 | —CO₂tBu | —H | —H | 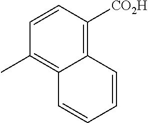 |
| 1-67 | —Ph | —Et | —H | 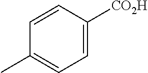 |
| 1-68 | —Ph | —Et | —H | 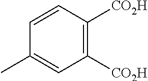 |
| 1-69 | —Ph | —Et | —H | 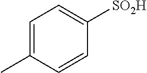 |
| 1-70 | —Ph | —Et | —H | 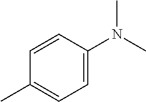 |
| 1-71 | —Ph | —Et | —H | 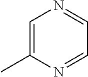 |
| 1-72 | —Ph | —Et | —H | 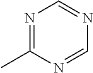 |
| 1-73 | —Ph | —Et | —H | 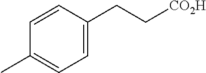 |
| 1-74 | —Ph | —Et | —H | 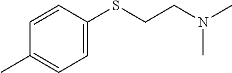 |
| 1-75 | —Ph | —Et | —H | 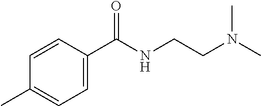 |
| 1-76 | —Ph | —Et | —H | 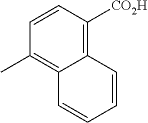 |
| 1-77 | 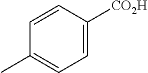 | —H | —H | 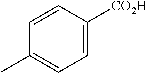 |
| 1-78 | 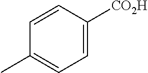 | —Me | —H | 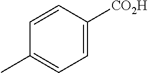 |
| 1-79 | 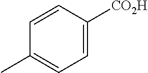 | —H | —H | 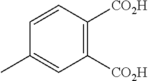 |
| 1-80 | 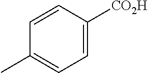 | —Me | —H | 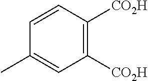 |

TABLE 2-1
Examples of compound represented by general formula (2)

| Exemplary | | | | |
|---|---|---|---|---|
| compound | R₁ | R₂ | R₃ | R₄ |
| 2-1 | —Me | —H | —H | 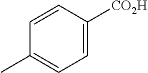 |
| 2-2 | —Me | —H | —H | 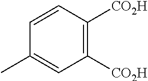 |
| 2-3 | —Me | —H | —H | 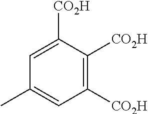 |
| 2-4 | —Me | —H | —H | 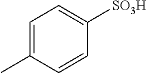 |
| 2-5 | —Me | —H | —H | 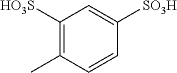 |
| 2-6 | —Me | —H | —H | 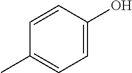 |
| 2-7 | —Me | —H | —H | 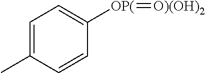 |
| 2-8 | —Me | —H | —H | 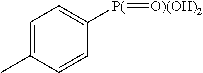 |
| 2-9 | —Me | —H | —H | 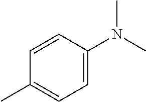 |
| 2-10 | —Me | —H | —H | 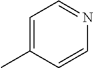 |
| 2-11 | —Me | —H | —H | 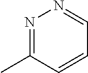 |
| 2-12 | —Me | —H | —H | 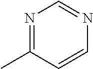 |
| 2-13 | —Me | —H | —H | 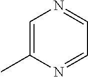 |
| 2-14 | —Me | —H | —H | 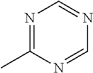 |
| 2-15 | —Me | —H | —H | 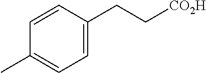 |
| 2-16 | —Me | —H | —H | 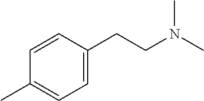 |
| 2-17 | —Me | —H | —H | 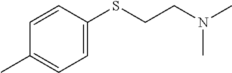 |
| 2-18 | —Me | —H | —H | 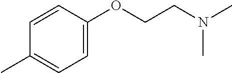 |
| 2-19 | —Me | —H | —H | 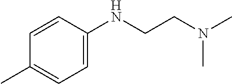 |
| 2-20 | —Me | —H | —H | 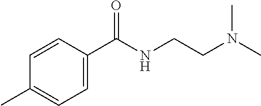 |
| 2-21 | —Me | —H | —H | 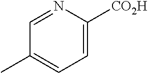 |
| 2-22 | —Me | —H | —H | 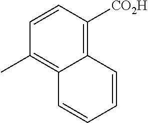 |
| 2-23 | —Me | —H | —H | 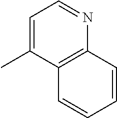 |
| 2-24 | —Me | —Me | —H | 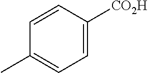 |
| 2-25 | —Me | —Me | —H | 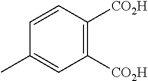 |
| 2-26 | —Me | —Me | —H | 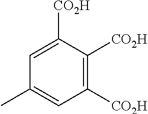 |
| 2-27 | —Me | —Me | —H | 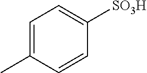 |
| 2-28 | —Me | —Me | —H | 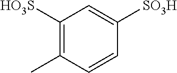 |
| 2-29 | —Me | —Me | —H | 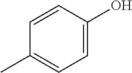 |
| 2-30 | —Me | —Me | —H | 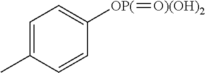 |
| 2-31 | —Me | —Me | —H | 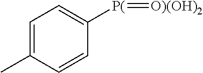 |
| 2-32 | —Me | —Me | —H | 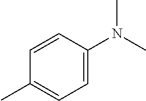 |
| 2-33 | —Me | —Me | —H | 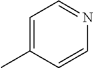 |
| 2-34 | —Me | —Me | —H | 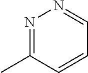 |
| 2-35 | —Me | —Me | —H | 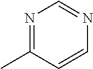 |
| 2-36 | —Me | —Me | —H | 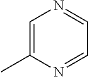 |
| 2-37 | —Me | —Me | —H | 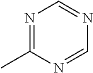 |
| 2-38 | —Me | —Me | —H | 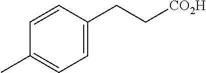 |
| 2-39 | —Me | —Me | —H | 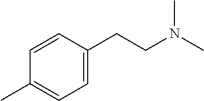 |
| 2-40 | —Me | —Me | —H | 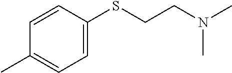 |

TABLE 2-2
Examples of compound represented by general formula (2)

| Exemplary | | | | |
|---|---|---|---|---|
| compound | R₁ | R₂ | R₃ | R₄ |
| 2-41 | —Me | —Me | —H | 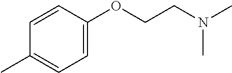 |
| 2-42 | —Me | —Me | —H | 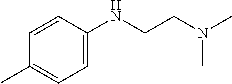 |
| 2-43 | —Me | —Me | —H | 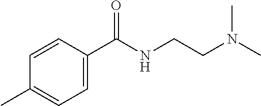 |
| 2-44 | —Me | —Me | —H | 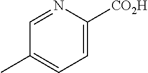 |
| 2-45 | —Me | —Me | —H | 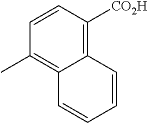 |
| 2-46 | —Me | —Me | —H | 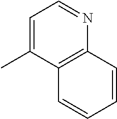 |
| 2-47 | —Et | —Me | —H | 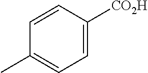 |
| 2-48 | —Et | —Me | —H | 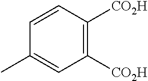 |
| 2-49 | —Et | —Me | —H | 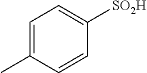 |
| 2-50 | —Et | —Me | —H | 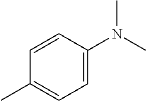 |
| 2-51 | —Et | —Me | —H | 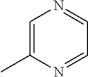 |
| 2-52 | —Et | —Me | —H | 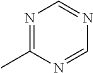 |
| 2-53 | —Et | —Me | —H | 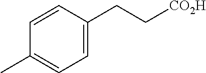 |
| 2-54 | —Et | —Me | —H | 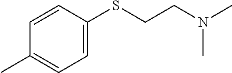 |
| 2-55 | —Et | —Me | —H | 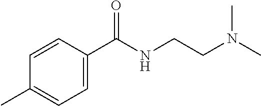 |
| 2-56 | —Et | —Me | —H | 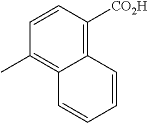 |
| 2-57 | —Ph | —H | —H | 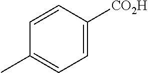 |
| 2-58 | —Ph | —H | —H | 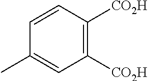 |
| 2-59 | —Ph | —H | —H | 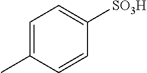 |
| 2-60 | —Ph | —H | —H | 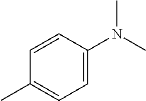 |
| 2-61 | —Ph | —H | —H | 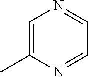 |
| 2-62 | —Ph | —H | —H | 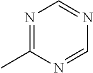 |
| 2-63 | —Ph | —H | —H | 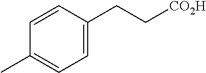 |
| 2-64 | —Ph | —H | —H | 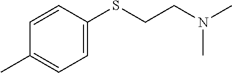 |
| 2-65 | —Ph | —H | —H | 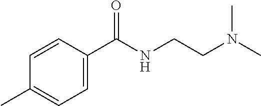 |
| 2-66 | —Ph | —H | —H | 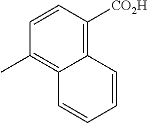 |
| 2-67 | —Ph | —Me | —H | 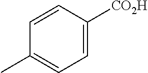 |
| 2-68 | —Ph | —Me | —H | 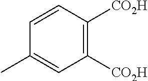 |
| 2-69 | —Ph | —Me | —H | 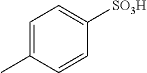 |
| 2-70 | —Ph | —Me | —H | 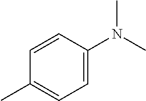 |
| 2-71 | —Ph | —Me | —H | 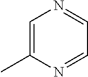 |
| 2-72 | —Ph | —Me | —H | 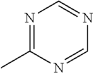 |
| 2-73 | —Ph | —Me | —H | 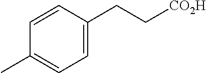 |
| 2-74 | —Ph | —Me | —H | 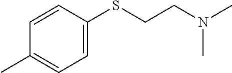 |
| 2-75 | —Ph | —Me | —H | 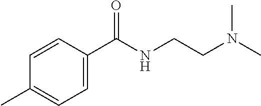 |
| 2-76 | —Ph | —Me | —H | 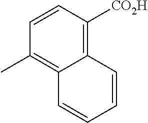 |
| 2-77 | —Ph | —Ph | —H | 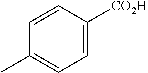 |
| 2-78 | —Ph | —Ph | —H | 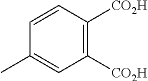 |
| 2-79 | —Ph | —Ph | —H | 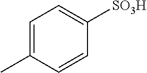 |
| 2-80 | —Ph | —Ph | —H | 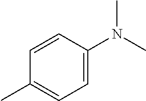 |

TABLE 2-3
Examples of compound represented by general formula (2)

| Exemplary | | | | |
|---|---|---|---|---|
| compound | R₁ | R₂ | R₃ | R₄ |
| 2-81 | —Ph | —Ph | —H | 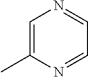 |
| 2-82 | —Ph | —Ph | —H | 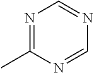 |
| 2-83 | —Ph | —Ph | —H | 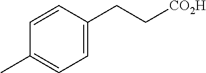 |
| 2-84 | —Ph | —Ph | —H | 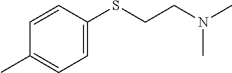 |
| 2-85 | —Ph | —Ph | —H | 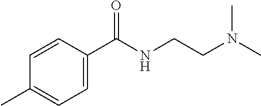 |
| 2-86 | —Ph | —Ph | —H | 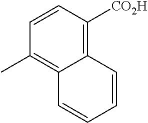 |
| 2-87 | 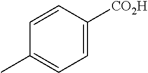 | —H | —H | —Me |
| 2-88 | 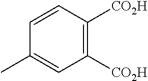 | —H | —H | —Me |
| 2-89 | 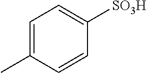 | —H | —H | —Me |
| 2-90 | 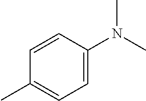 | —H | —H | —Me |
| 2-91 | 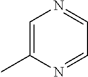 | —H | —H | —Me |
| 2-92 | 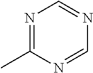 | —H | —H | —Me |
| 2-93 | 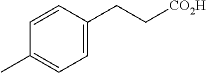 | —H | —H | —Me |
| 2-94 | 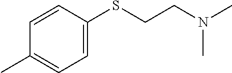 | —H | —H | —Me |
| 2-95 | 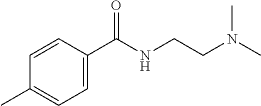 | —H | —H | —Me |
| 2-96 | 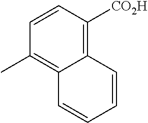 | —H | —H | —Me |
| 2-97 | 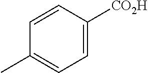 | —H | —H | —Ph |
| 2-98 | 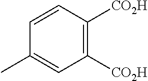 | —H | —H | —Ph |
| 2-99 | 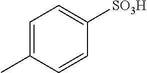 | —H | —H | —Ph |
| 2-100 | 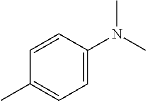 | —H | —H | —Ph |
| 2-101 | 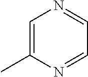 | —H | —H | —Ph |
| 2-102 | 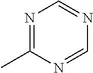 | —H | —H | —Ph |
| 2-103 | 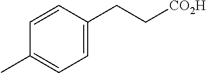 | —H | —H | —Ph |
| 2-104 | 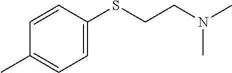 | —H | —H | —Ph |
| 2-105 | 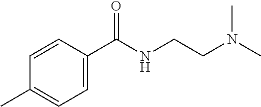 | —H | —H | —Ph |
| 2-106 | 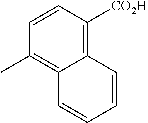 | —H | —H | —Ph |
| 2-107 | 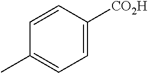 | —H | —H | —CO₂tBu |
| 2-108 | 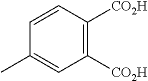 | —H | —H | —CO₂tBu |
| 2-109 | 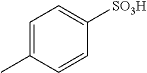 | —H | —H | —CO₂tBu |
| 2-110 | 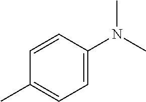 | —H | —H | —CO₂tBu |
| 2-111 | 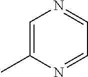 | —H | —H | —CO₂tBu |
| 2-112 | 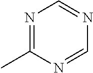 | —H | —H | —CO₂tBu |
| 2-113 | 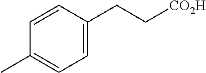 | —H | —H | —CO₂tBu |
| 2-114 | 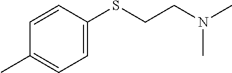 | —H | —H | —CO₂tBu |
| 2-115 | 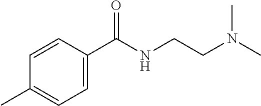 | —H | —H | —CO₂tBu |
| 2-116 | 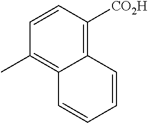 | —H | —H | —CO₂tBu |
| 2-117 | 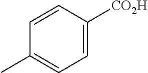 | —Me | —H | —CO₂tBu |
| 2-118 | 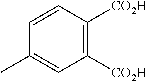 | —Me | —H | —CO₂tBu |
| 2-119 | 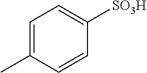 | —Me | —H | —CO₂tBu |
| 2-120 | 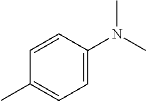 | —Me | —H | —CO₂tBu |

TABLE 2-4
Examples of compound represented by general formula (2)

| Exemplary | | | | |
|---|---|---|---|---|
| compound | R₁ | R₂ | R₃ | R₄ |
| 2-121 | 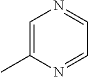 | —Me | —H | —CO₂tBu |
| 2-122 | 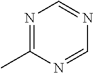 | —Me | —H | —CO₂tBu |
| 2-123 | 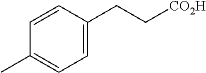 | —Me | —H | —CO₂tBu |
| 2-124 | 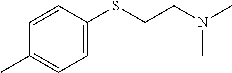 | —Me | —H | —CO₂tBu |
| 2-125 | 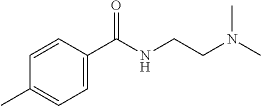 | —Me | —H | —CO₂tBu |
| 2-126 | 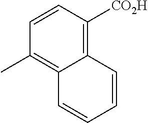 | —Me | —H | —CO₂tBu |
| 2-127 | 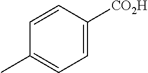 | —H | —H | —CO₂Ph |
| 2-128 | 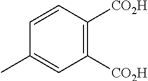 | —H | —H | —CO₂Ph |
| 2-129 | 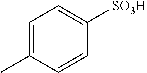 | —H | —H | —CO₂Ph |
| 2-130 | 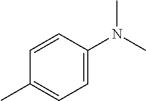 | —H | —H | —CO₂Ph |
| 2-131 | 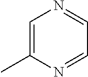 | —H | —H | —CO₂Ph |
| 2-132 | 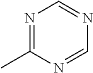 | —H | —H | —CO₂Ph |
| 2-133 | 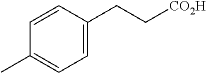 | —H | —H | —CO₂Ph |
| 2-134 | 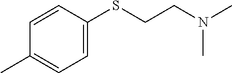 | —H | —H | —CO₂Ph |
| 2-135 | 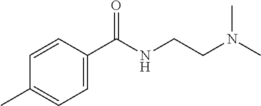 | —H | —H | —CO₂Ph |
| 2-136 | 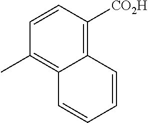 | —H | —H | —CO₂Ph |
| 2-137 | 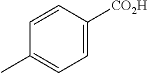 | —H | —H | 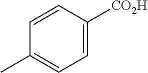 |
| 2-138 | 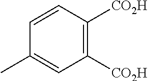 | —H | —H | 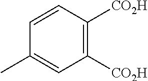 |
| 2-139 | 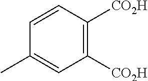 | —H | —H | 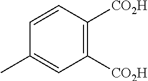 |
| 2-140 | 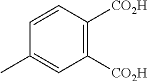 | —Me | —H | 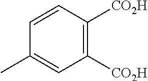 |

TABLE 3
Examples of compound represented by general formula (3)

| Exemplary | | |
|---|---|---|
| compound | R₁ | R₂ |
| 3-1 | 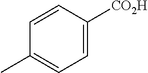 | 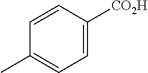 |
| 3-2 | 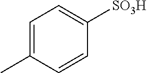 | 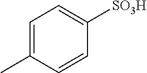 |
| 3-3 | 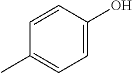 | 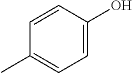 |
| 3-4 | 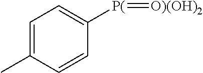 | 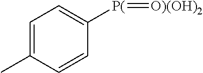 |
| 3-5 | 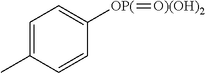 | 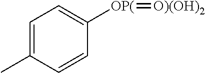 |
| 3-6 | 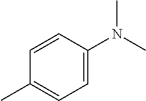 | 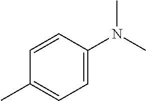 |
| 3-7 | 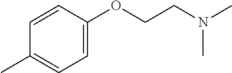 | 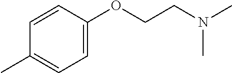 |
| 3-8 | 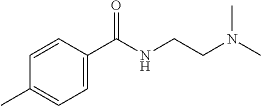 | 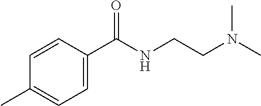 |
| 3-9 | 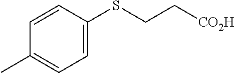 | 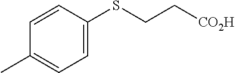 |
| 3-10 | 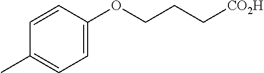 | 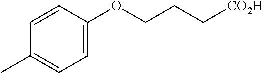 |
| 3-11 | 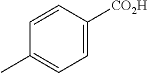 | 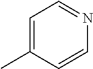 |
| 3-12 | 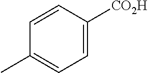 | —Ph |
| 3-13 | 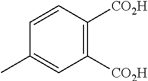 | 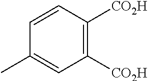 |
| 3-14 | 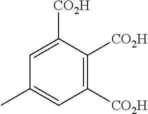 | 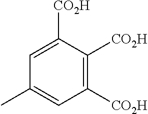 |
| 3-15 | 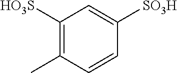 | 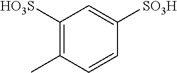 |
| 3-16 | 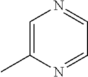 | 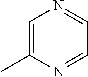 |
| 3-17 | 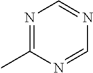 | 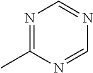 |
| 3-18 | 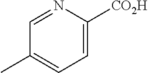 | 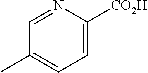 |
| 3-19 | 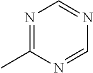 | —Ph |
| 3-20 | 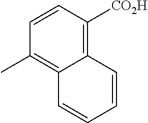 | 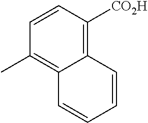 |
| 3-21 | 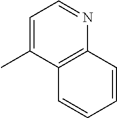 | 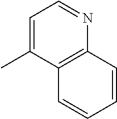 |
| 3-22 | 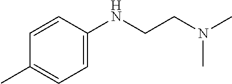 | 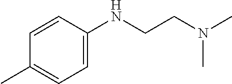 |
| 3-23 | 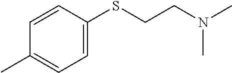 | 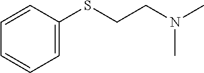 |
| 3-24 | 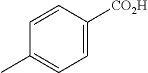 | 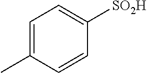 |
| 3-25 | 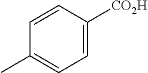 | 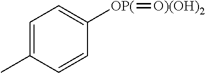 |
| 3-26 | 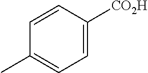 | 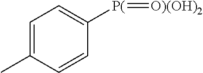 |
| 3-27 | 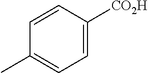 | 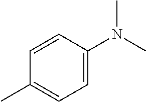 |

TABLE 4
Examples of compound represented by general formula (4)

| Exemplary | | |
|---|---|---|
| compound | R₁ | R₂ |
| 4-1 | 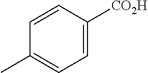 | 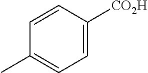 |
| 4-2 | 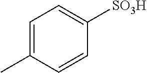 | 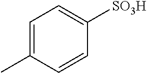 |
| 4-3 | 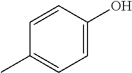 | 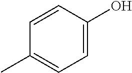 |
| 4-4 | 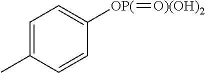 | 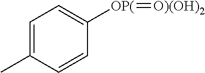 |
| 4-5 | 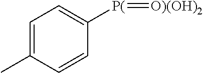 | 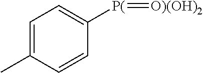 |
| 4-6 | 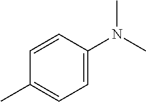 | 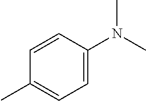 |
| 4-7 | 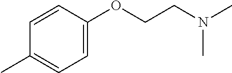 | 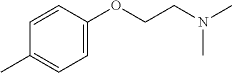 |
| 4-8 | 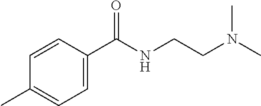 | 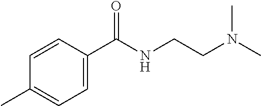 |
| 4-9 | 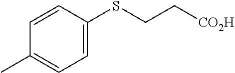 | 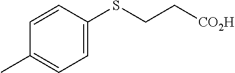 |
| 4-10 | 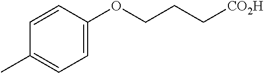 | 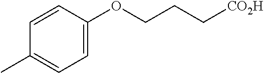 |
| 4-11 | 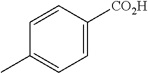 | 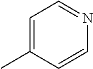 |
| 4-12 | 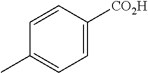 | —Ph |
| 4-13 | 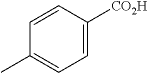 | 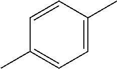 |
| 4-14 | 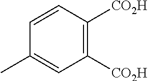 | 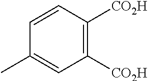 |
| 4-15 | 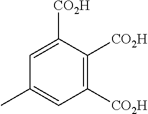 | 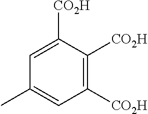 |
| 4-16 | 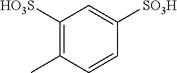 | 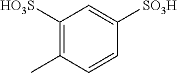 |
| 4-17 | 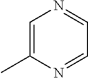 | 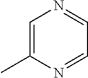 |

TABLE 5
Examples of compound represented by general formula (5)

| Exemplary | |
|---|---|
| compound | R₁ |
| 5-1 | 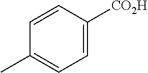 |
| 5-2 | 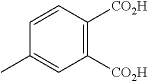 |
| 5-3 | 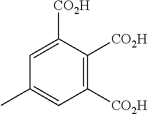 |
| 5-4 | 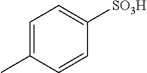 |
| 5-5 | 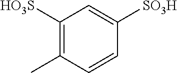 |
| 5-6 | 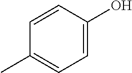 |
| 5-7 | 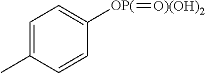 |
| 5-8 | 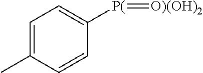 |
| 5-9 | 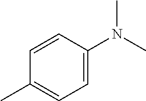 |
| 5-10 | 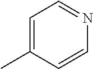 |
| 5-11 | 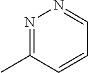 |
| 5-12 | 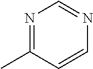 |
| 5-13 | 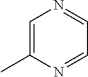 |
| 5-14 | 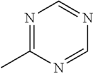 |
| 5-15 | 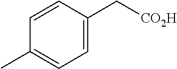 |
| 5-16 | 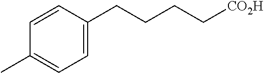 |
| 5-17 | 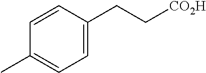 |
| 5-18 | 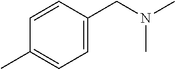 |
| 5-19 | 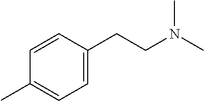 |
| 5-20 | 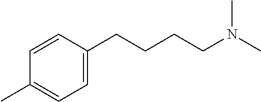 |
| 5-21 | 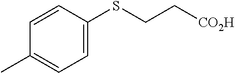 |
| 5-22 | 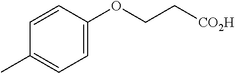 |
| 5-23 | 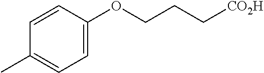 |
| 5-24 | 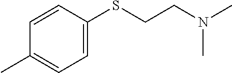 |
| 5-25 | 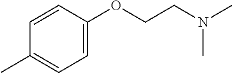 |
| 5-26 | 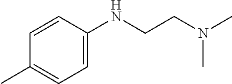 |
| 5-27 | 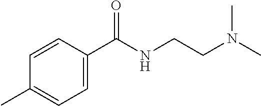 |
| 5-28 | 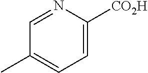 |
| 5-29 | 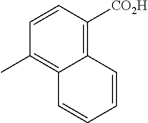 |
| 5-30 | 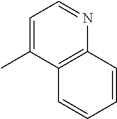 |

TABLE 6
Examples of compound represented by general formula (6)

| Exemplary | | | | | | |
|---|---|---|---|---|---|---|
| compound | R₁ | R₂ | R₃ | R₄ | R₅ | R₆ |
| 6-1 | —H | —H | —H | —H | —H | —H |
| 6-2 | —Me | —H | —H | —H | —H | —H |
| 6-3 | —H | —CO₂H | —H | —H | —H | —H |
| 6-4 | —H | —H | —CO₂H | —H | —H | —CO₂H |
| 6-5 | —H | —H | —CO₂H | —H | —H | —H |
| 6-6 | —H | —H | —H | —H | —CO₂H | —H |
| 6-7 | —H | —CO₂H | —H | —H | —H | —CO₂H |
| 6-8 | —H | —CO₂H | —CO₂H | —H | —H | —CO₂H |
| 6-9 | —H | —H | —H | —H | —H | —H |
| 6-10 | —H | —H | —H | —H | —H | —H |
| 6-11 | —H | —H | —H | —H | —H | —H |
| 6-12 | —H | —H | —H | —H | —H | —H |
| 6-13 | —H | —H | —H | —H | —H | —H |
| 6-14 | —H | —Me | —H | —H | —H | —H |
| 6-15 | —H | —H | —SO₃H | —H | —H | —SO₃H |
| 6-16 | —H | —PO₃H₂ | —H | —H | —H | —H |
| 6-17 | —H | —H | —H | —H | —H | —H |
| 6-18 | —Me | —H | —H | —H | —H | —H |
| 6-19 | —H | —OH | —H | —H | —H | —H |
| 6-20 | —H | —CH₂—OH | —H | —H | —H | —H |
| 6-21 | —H | —H | —H | —H | —H | —H |
| 6-22 | —H | —H | —H | —H | —H | —H |
| 6-23 | —H | —N(Me)₂ | —H | —H | —H | —H |
| 6-24 | —H | —H | —H | —H | —H | —O—CH₂—COOH |
| 6-25 | —H | —H | —H | —H | —H | —H |
| 6-26 | —H | —H | —H | —H | —H | —H |
| 6-27 | —H | —H | —H | —H | —H | —H |
| 6-28 | —H | —H | —H | —H | —H | —2Py |
| 6-29 | —H | —H | —H | —H | —H | —H |

| Exemplary | | |
|---|---|---|
| compound | R₇ | R₈ |
| 6-1 | —CO₂H | —H |
| 6-2 | —CO₂H | —H |
| 6-3 | —CO₂H | —H |
| 6-4 | —H | —H |
| 6-5 | —CO₂H | —H |
| 6-6 | —CO₂H | —H |
| 6-7 | —CO₂H | —H |
| 6-8 | —CO₂H | —H |
| 6-9 | —CH₂—CO₂H | —H |
| 6-10 | —O—CH₂—CO₂H | —H |
| 6-11 | —S—CH₂—CO₂H | —H |
| 6-12 | —C≡C—CH₂—CO₂H | —H |
| 6-13 | —SO₃H | —H |
| 6-14 | —SO₃H | —H |
| 6-15 | —H | —H |
| 6-16 | —PO₃H₂ | —H |
| 6-17 | —OH | —H |
| 6-18 | —OH | —H |
| 6-19 | —OH | —H |
| 6-20 | —CH₂—OH | —H |
| 6-21 | —N(Me)₂ | —H |
| 6-22 | —CH₂—CH₂—N(Me)₂ | —H |
| 6-23 | —N(Me)₂ | —H |
| 6-24 | —H | —Ph |
| 6-25 | —O—CH₂—CO₂H | —2Py |
| 6-26 | —O—CH₂—CH₂—CH₂—CO₂H | —2Py |
| 6-27 | —Ph | —O—CH₂—CH₂—CO₂H |
| 6-28 | —H | —O—CH₂—CH₂—CO₂H |
| 6-29 | —2Py | —O—CH₂—CH₂—CH₂—CO₂H |

TABLE 7
Examples of compound represented by general formula (7)

| Exemplary | | | | |
|---|---|---|---|---|
| compound | R₁ | R₂ | R₃ | R₄ |
| 7-1 | —H | —H | —H | —H |
| 7-2 | —H | —H | —H | —H |
| 7-3 | —H | —H | —H | —H |
| 7-4 | —H | —H | —OH | —H |
| 7-5 | —H | —H | —OH | —H |
| 7-6 | —H | —H | —S—CH₂—CO₂H | —H |
| 7-7 | —Me | —H | —S—CH₂—CO₂H | —H |
| 7-8 | —Me | —H | —S—CH₂—CO₂H | —H |
| 7-9 | —H | —O—CH₂—CO₂H | —H | —H |
| 7-10 | —H | —O—CH₂—CO₂H | —H | —H |
| 7-11 | —H | —H | —H | —H |
| 7-12 | —H | —H | —H | —H |
| 7-13 | —H | —H | —H | —H |
| 7-14 | —O—CH₂—CH₂—CO₂H | —H | —H | —H |
| 7-15 | —S—CH₂—CH₂—N(Me)₂ | —H | —H | —H |
| 7-16 | —S—CH₂—CH₂—CH₂—N(Me)₂ | —H | —H | —H |
| 7-17 | —S—CH₂—CH₂—CH₂—N(Et)₂ | —H | —H | —H |
| 7-18 | —H | —H | —OH | —H |

| Exemplary | | | | |
|---|---|---|---|---|
| compound | R₅ | R₆ | R₇ | R₈ |
| 7-1 | —H | —H | —CO₂H | —H |
| 7-2 | —H | —H | —SO₃H | —H |
| 7-3 | —H | —H | —PO₃H₂ | —H |
| 7-4 | —H | —H | —CO₂H | —H |
| 7-5 | —H | —H | —PO₃H₂ | —H |
| 7-6 | —H | —H | —H | —H |
| 7-7 | —H | —H | —H | —H |
| 7-8 | —H | —S—CH₂—CO₂H | —H | —Me |
| 7-9 | —H | —H | —COOH | —H |
| 7-10 | —H | —OH | —COOH | —H |
| 7-11 | —H | —H | —H | —CH₂—CH₂—CH₂—N(Me)₂ |
| 7-12 | —H | —H | —H | —S—CH₂—CH₂—N(Me)₂ |
| 7-13 | —H | —H | —H | —S—CH₂—CH₂—N(Et)₂ |
| 7-14 | —H | —H | —H | —O—CH₂—CH₂—CO₂H |
| 7-15 | —H | —H | —H | —S—CH₂—CH₂—N(Me)₂ |
| 7-16 | —H | —H | —H | —S—CH₂—CH₂—CH₂—N(Me)₂ |
| 7-17 | —H | —H | —H | —S—CH₂—CH₂—CH₂—N(Et)₂ |
| 7-18 | —H | —H | —H | —SO₃H |

The use of any of the compounds represented by the general formulae (1) to (7) as the treatment agent for coating the metal particle enables the metal particle to be stably dispersed in a liquid medium. Of those, the compounds represented by the general formulae (1), (2), (6) and (7) are preferred and the compounds represented by the general formulae (1) and (2) are more preferred because the compounds are each excellent in dispersion stability of the metal particle and stability of the treatment agent. Meanwhile, in the case of the compounds represented by the general formulae (3) to (5), some of the treatment agents may cause the particle coated therewith to have a slightly low zeta potential (absolute value), and hence the dispersion stability tends to be relatively low. In addition, in the case of the compounds represented by the general formulae (3) to (5), stability of the treatment agent is liable to be relatively low, and hence the compounds represented by the general formulae (1), (2), (6) and (7) are more preferred.

### (Liquid Medium)

The conductive composition may further contain a liquid medium. As the liquid medium, any of a non-aqueous medium and an aqueous medium may be used. An example of the non-aqueous medium may be a liquid medium formed of an organic solvent, such as heptane or petroleum ether. The non-aqueous medium is free of water. The aqueous medium contains water, and may further contain various organic solvents. The conductive composition preferably further contains the aqueous medium.

The aqueous medium is water or a mixed medium of water as a main component and a protic organic solvent or an aprotic organic solvent in combination. As the organic solvent, an organic solvent miscible with water at any ratio (water-miscible organic solvent) or an organic solvent soluble in water at any ratio (water-soluble organic solvent) is preferably used. Of those, a uniform mixed medium containing 50% by mass or more of water is preferably used as the aqueous medium. As the water, deionized water (ion-exchanged water) or ultrapure water is preferably used.

The protic organic solvent is an organic solvent having a hydrogen atom (acidic hydrogen atom) bonded to an oxygen atom or a nitrogen atom. The aprotic organic solvent is an organic solvent free of an acidic hydrogen atom. Examples of the organic solvent may include alcohols, (poly)alkylene glycols, glycol ethers, glycol ether esters, carboxylic acid amides, ketones, ketoalcohols, cyclic ethers, nitrogen-containing solvents and sulfur-containing solvents.

Examples of the aqueous medium may include water, a mixed solvent of water and an alcohol, a mixed solvent of water and a (poly)alkylene glycol and a mixed solvent of water and a nitrogen-containing solvent. The content (% by mass) of water in the conductive composition is preferably 10.0% by mass or more to 90.0% by mass or less, more preferably 50.0% by mass or more to 90.0% by mass or less with respect to the total mass of the conductive composition.

The content (% by mass) of the water-soluble organic solvent in the conductive composition is preferably 5.0% by mass or more to 90.0% by mass or less, more preferably 10.0% by mass or more to 50.0% by mass or less with respect to the total mass of the conductive composition.

### (Other Additive)

The conductive composition may further contain: a polyhydric alcohol, such as trimethylolpropane or trimethylolethane; urea or a urea derivative such as ethylene urea; or a water-soluble organic compound, as required. In addition, the conductive composition may further contain any of various additives, such as a surfactant, a pH adjuster, a rust inhibitor, an antiseptic, an antifungal agent, an antioxidant, an anti-reducing agent, an evaporation accelerator, a chelating agent and a resin, as required.

As the surfactant, for example, any of anionic, cationic and nonionic surfactants may be used. The content (% by mass) of the surfactant in the conductive composition is preferably 0.1% by mass or more to 5.0% by mass or less, more preferably 0.1% by mass or more to 2.0% by mass or less with respect to the total mass of the conductive composition.

As the surfactant, a nonionic surfactant, such as a polyoxyethylene alkyl ether, a polyoxyethylene fatty acid ester, a polyoxyethylene alkyl phenyl ether, a polyoxyethylene-polyoxypropylene block copolymer or an acetylene glycol-based compound, is preferably used.

### Method of producing Conductive Composition

Next, a method of producing the above-mentioned conductive composition is described. The method of producing the conductive composition of the present invention includes a first step of reducing a metal salt in an aqueous medium to form the metal particle and a second step of bringing the formed metal particle into contact with the treatment agent.

### (First Step)

In the first step, a metal salt is reduced in an aqueous medium to form a metal particle. The aqueous medium described in the foregoing that may be incorporated in the conductive composition may be used as the aqueous medium. Examples of the metal salt may include a metal salt formed of a metal ion and an inorganic anion species, a metal salt formed of a metal ion and an organic anion species and a metal salt formed of a metal ion and an inorganic/organic anion species. As the metal ion, an ion of a metal that may form a metal particle, such as nickel, palladium, platinum, copper, silver or gold, may be used. Examples of the inorganic anion species may include anions of, for example, an oxide, a halogen, carbonic acid and nitric acid. Examples of the organic anion species may include anions of carboxylic acids, such as formic acid and acetic acid.

Specific examples of the metal salt may include: nickel compounds, such as nickel(II) chloride and nickel(II) nitride; palladium compounds, such as palladium(II) chloride, palladium(II) acetate and palladium(II) oxide; platinum compounds, such as platinum(II) chloride and platinum(IV) oxide; copper compounds, such as copper(I) chloride, copper(II) chloride, copper(I) oxide and copper(II) oxide; silver compounds, such as silver(I) chloride, silver nitride, silver oxide and silver acetate; and gold compounds, such as gold(III) oxide, gold(I) chloride, tetragold octachloride, gold(III) chloride, gold(III) bromide, gold(III) fluoride, gold(V) fluoride, gold(I) hydroxide and gold(III) hydroxide.

In recent years, there is a possibility that resources of a material, such as a noble metal or a rare metal, which is used in an electronic device and the like, may be depleted in several decades when the material is kept being used. Such material is called a critical material, and in order not to deplete the resource, an effort of recovering those resources from a used noble metal product or a waste electronic device to recycle those resources has been performed in each country. Of those, recycling of a noble metal, such as platinum, gold or silver, has been advanced as compared to other resources, and a regeneration technology has also been established. As a method of regenerating gold, there is given, for example, a method including removing any other metal from a recovered waste product, dissolving and leaching gold with aqua regia or an organic solvent, followed by recrystallizing gold with a reducing agent to increase its purity and further melting the resultant to form a lump having removed organic matter therefrom. When the recovered noble metal is reused as a product, purity guarantee is needed. For example, in the case of gold, a high purity of 99.99% needs to be guaranteed.

From such viewpoint, a recovered metal salt recovered from a metal waste liquid is also preferably used as the metal salt. For example, when a conductive composition containing a gold particle as the metal particle is produced, chloroauric(III) acid utilizing the recovered gold may be used. Chloroauric(III) acid may be prepared by drying a gold-aqua regia solution generated in the middle of the above-mentioned method of regenerating gold.

When the conductive composition containing a gold particle as the metal particle is produced, the regenerated chloroauric(III) acid may be used as one of starting raw materials. Gold has high reducing property, and hence even when the regenerated chloroauric(III) acid contains another metal impurity, the gold particle is preferentially formed. Accordingly, high purity guarantee is unnecessary for the regenerated chloroauric(III) acid. The purity of chloroauric(III) acid is preferably 90% or more, more preferably 95% or more. In a regeneration process for gold, a step in association with purity guarantee can be omitted to suppress a raw material cost.

In addition, when a conductive composition containing a silver particle as the metal particle is produced, high purity guarantee is unnecessary for silver(I) nitrate that may be used as one of starting raw materials. The purity of silver(I) nitrate is preferably 90% or more, more preferably 95% or more. In a regeneration process for silver, a step in association with purity guarantee can be omitted to suppress a raw material cost.

Silver(I) nitrate may be recovered from a waste in accordance with a known method. For example, when a dichromate salt is added to a filtrate obtained by adding nitric acid to a waste liquid containing silver to acidulate the liquid and separating a precipitate, silver dichromate is generated as a precipitate. Silver(I) nitrate may be recovered by dissolving the precipitate of silver dichromate in hot dilute nitric acid, followed by treatment with a NO₃-type anion-exchanged resin.

A reducing agent is preferably used for reducing the metal salt. Examples of the reducing agent may include: alcohols each having a primary hydroxy group, such as methanol, ethanol, 1-propanol and ethylene glycol; alcohols each having a secondary hydroxy group, such as 2-propanol and 2-butanol; alcohols each having a primary hydroxy group and a secondary hydroxy group, such as glycerin; thiols; aldehydes, such as formaldehyde and acetaldehyde; sugars, such as glucose, fructose, glycerylaldehyde, lactose, arabinose and maltose; organic acids, such as citric acid, tannic acid and ascorbic acid and salts thereof; borohydrides and salts thereof; and hydrazines, such as hydrazine, an alkylhydrazine and hydrazine sulfate. As an anion for forming a salt of the organic acid or the borohydride, there may be given, for example: alkali metal ions, such as lithium, sodium and potassium; alkaline earth metal ions, such as calcium and magnesium; an ammonium ion; and organic ammonium ions.

Of those, organic acids and salts thereof are preferably used as the reducing agent. The organic acids and salts thereof each reduce a metal salt and adhere to the surface of the metal particle to be formed, to thereby enable a repulsive force to such a degree as not to cause aggregation or coalescence of the metal particles to be generated. As the organic acids and salts thereof, for example, ascorbic acid and salts thereof and citric acid and salts thereof are preferred. Of those, for example, an ascorbic acid salt and a citric acid salt are more preferred.

In addition, a compound, such as polyvinylpyrrolidone, polyvinyl alcohol, polyethylene glycol, gelatin, starch, dextrin, carboxymethyl cellulose, methyl cellulose or ethyl cellulose, may be used as the reducing agent. Those compounds each also reduce a metal salt and adhere to the surface of the metal particle to be formed, to thereby enable a repulsive force to such a degree as not to cause aggregation or coalescence of the metal particles to be generated in the same manner as in the organic acids and salts thereof.

The usage amount of the reducing agent only needs to be appropriately set in accordance with, for example, the kind of the metal, the concentration of the metal salt, the size (particle diameter) of the metal particle to be formed and a temperature and a stirring force when the reducing agent is added. In the first step, the metal salt is preferably reduced while being vigorously stirred. In addition, in the first step, the metal salt is preferably reduced under a heating condition and the metal salt is more preferably reduced while the aqueous medium is refluxed. For example, when water is used as the aqueous medium, the temperature is preferably set to 115° C. or more to 200° C. or less. The temperature can be adjusted by the temperature of an oil bath for heating a reaction vessel.

The metal particle only reduced with the reducing agent and not coated with the treatment agent shows a value of a zeta potential in accordance with the kind of the reducing agent. For example, in Examples to be described below, the gold particle is formed by using citric acid as the reducing agent. The zeta potential of the gold particle having citric acid adhering thereto is about −40 mV. However, the reducing agent such as citric acid has a weak adhesive force to the metal particle, and hence a conductive composition in which a metal particle is continuously stably dispersed is not achieved.

### (Second Step)

In the second step, the metal particle formed in the first step and the treatment agent are brought into contact with each other. Specifically, the metal particle and the treatment agent only need to be mixed in an aqueous medium. Thus, the target conductive composition can be obtained. When the amount of the treatment agent is set to such an amount as to uniformly cover the surfaces of all of the metal particles (when the amount is not set to an excessive amount), an approximate amount may be grasped in accordance with the following method.

When the particle diameter of the metal particle is determined, a surface area per metal particle can be calculated. Accordingly, when an occupied area per molecule of the treatment agent can be estimated, the number of molecules for coating the surface of one metal particle can be calculated. The occupied area may be determined as an estimated value by setting the diameter of an atom to 1.5 Å to calculate a sectional area and multiplying the sectional area by the number of the atoms of the treatment agent.

In addition, a saturated adsorption amount for coating the metal particle may be estimated, and the estimated amount may be used as the addition amount of the treatment agent as a guideline. Specifically, the adsorption amount is plotted with respect to the addition amount of the treatment agent. When the obtained plot (adsorption isotherm) is a curve in accordance with a Langmuir-type adsorption isotherm, a region in which, even when the addition amount is increased, the adsorption amount is not increased and saturated is present. Accordingly, the adsorption amount in this region can be regarded as the saturated adsorption amount. In the second step, the metal particle and the treatment agent are preferably brought into contact with each other while being heated to 20° C. or more to 50° C. or less. A residue of the reducing agent used in the first step may adhere to a metal particle surface as an impurity. It is considered that, when the heating is performed at 20° C. or more to 50° C. or less, replacement with the treatment agent having stronger interaction advances while the impurity is removed.

### Method of Recording Conductive Image

Next, a method of recording a conductive image is described. The method of recording a conductive image of the present invention includes a step of applying the above-mentioned conductive composition to a base material. When the conductive composition is applied to the base material, a desired conductive image can be obtained. As a method of applying the conductive composition to the base material, there may be given, for example, an ink jet method, a flexo method and a spin coating method. Of those, the conductive composition is preferably applied to the base material by an ink jet method. The ink jet method is a method of ejecting the conductive composition from an ejection head of an ink jet system to apply the composition to the base material such as a recording medium. A system of ejecting the conductive composition from the ejection head is, for example, a system involving applying mechanical energy to the conductive composition or a system involving applying thermal energy to the conductive composition. The method of applying the conductive composition to the base material by the ink jet method only needs to be a known method except that the above-mentioned conductive composition is used.

When the conductive image is recorded (formed) by ejecting the conductive composition from the ejection head of the ink jet system to apply the composition to the base material, a conductive composition in which its surface tension and viscosity are appropriately controlled is preferably used. Specifically, the content (% by mass) of the metal particle in the conductive composition is preferably 5.0% by mass or more to 20.0% by mass or less with respect to the total mass of the composition. When the content of the metal particle in the conductive composition is less than 5.0% by mass, the amount of the conductive composition required for forming a film-shaped conductive image may be too large. Meanwhile, when the content of the metal particle in the conductive composition is more than 20.0% by mass, an ejection orifice of the ejection head may be easily clogged.

The surface tension of the conductive composition at 25° C. is preferably 10 mN/m or more to 60 mN/m or less, more preferably 20 mN/m or more to 60 mN/m or less, particularly preferably 30 mN/m or more to 50 mN/m or less. The viscosity of the conductive composition at 25° C. is preferably 1.0 mPa·s or more to 10 mPa·s, more preferably 1.0 mPa·s or more to 5 mPa·s or less. The pH of the conductive composition at 25° C. is preferably 5.0 or more to 9.0 or less.

The method of recording a conductive image may further include a step of drying the conductive composition applied to the base material. When the conductive composition is used, the conductive image having excellent conductivity can be formed by only performing drying at low temperature such as normal temperature (25° C.) even when the composition is not dried at high temperature of, for example, 100° C. or more. The conductive composition applied to the base material may be dried by, for example, air blowing or heating, but may be dried without utilizing these methods, that is, naturally dried. The conductive composition applied to the base material may be dried at a temperature of preferably 20° C. or more to 120° C. or less, more preferably 20° C. or more to 50° C. or less. When the drying temperature is less than 20° C., the time period required for the drying may become longer. When the drying time is shortened, conductivity of the conductive image to be recorded easily becomes high. When the base material has a high heat-resistant temperature, the drying temperature may also be increased to the heat-resistant temperature. In the recording method of the present invention, after the application of the conductive composition to the base material, a step of heating or sintering the conductive composition or a step of curing the conductive composition by irradiation with, for example, an active energy ray may not be performed.

### Conductive Image

A conductive image of the present invention is a conductive image including a base material and a conductive layer formed on the base material, in which the conductive layer contains a metal particle in which at least part of its particle surface is coated with the above-mentioned treatment agent. The conductive image of the present invention is suitably a conductive image to be recorded on the base material, that is, an image formed with the above-mentioned conductive composition.

### (Base Material)

The base material may be any base material on which the conductive image may be formed by, for example, drying the applied conductive composition. The conductive composition expresses conductivity even through drying at low temperature, and hence a base material having low heat-resistant temperature may also be used. For example, glass, paper, a resin material, ceramics and silicon are each preferably used as the base material.

Examples of the resin material may include: synthetic resins, such as polyethylene terephthalate, polyimide and polyethylene glycol; and synthetic resins and natural resins each having biocompatibility, such as polyhydroxybutyric acid, polycyanoacrylate, polyanhydride, polyketone, poly(orthoester), poly-ε-caprolactone, polyacetal, a poly(α-hydroxy ester), polycarbonate, poly(iminocarbonate), polyphosphazene, a poly(β-hydroxy ester), polypeptide, gelatin, cellulose, chitosan, collagen and fibroin. The resin material preferably has a sheet shape.

A biocompatible material is preferably used as the resin material. As the biocompatible material, a sheet-shaped material formed of a resin, such as polyhydroxybutyric acid, polycyanoacrylate, polyanhydride, polyketone, poly(orthoester), poly-ε-caprolactone, polyacetal, poly(α-hydroxy ester), polycarbonate, poly(iminocarbonate), polyphosphazene, poly(β-hydroxy ester), polypeptide, gelatin, cellulose, chitosan, collagen or fibroin, is preferred. Of those, a biocompatible material formed of at least one kind of natural polymer selected from the group consisting of: gelatin; cellulose; chitosan; collagen; and fibroin is preferred.

### EXAMPLES

Next, the present invention is described in more detail by way of Examples and Comparative Examples. However, the present invention is by no means limited to Examples below without departing from the gist of the present invention. In the description of the amounts of components, “part(s)” and “%” are by mass unless otherwise specified.

### Synthesis of Treatment Agent

Of the treatment agents, a treatment agent not commercially available as a reagent was synthesized in accordance with a known method described in each of the following documents. In addition, a treatment agent except the treatment agent whose synthesis example is described was synthesized in the same manner except that a starting substance was changed to a starting substance having a corresponding structure. The structure of the synthesized compound was analyzed and identified by liquid chromatography/mass spectrometry (LC/MS) (product name: “LC/MSD TOF”, manufactured by Agilent Technologies). An electrospray ionization method (ESI) was used as an ionization method.
Journal of the American Chemical Society, 2007, Vol. 129, No. 34, pp. 10,320-10,321
Tetrahedron Letters, 2007, Vol. 48, No. 48, pp. 8,409-8,412
Nature Chemistry, 2017, Vol. 9, No. 3, pp. 234-243

### Exemplary Compound 1-1

0.94 g of 1,1-dimethylhydrazine, 220 mg of Pd₂(dba)₃·CHCl₃ (manufactured by FUJIFILM Wako Pure Chemical Corporation), 140 mg of P(t-Bu)3HBF4 (manufactured by Tokyo Chemical Industry Co., Ltd.) and 8.1 g of cesium carbonate were added to 100 mL of toluene to provide a suspension. Under an argon atmosphere, 2.4 g of ethyl 4-bromobenzoate was added to the suspension, and the mixture was heated to reflux at 100° C. for 12 hours. After the mixture was cooled to room temperature, water was added thereto, and the resultant was extracted with toluene. A toluene layer was concentrated with a rotary evaporator, and the obtained component was purified by column chromatography to provide 0.9 g of ethyl (2,2-dimethylhydrazinyl)benzoate. A sodium hydroxide aqueous solution was added thereto and the mixture was stirred at 25° C. for 3 hours. A solid generated by adding thereto hydrochloric acid was filtered out to provide 0.8 g of an exemplary compound 1-1 (m/z=180.1, yield: 37%).

### Exemplary Compound 2-1

0.6 g of acetaldehyde was added to a solution of 1.5 g of 4-hydrazinobenzoic acid in 20 mL of ethanol, and the mixture was stirred at 70° C. for 5 hours. After the mixture was cooled to 25° C., a liquid was removed with a rotary evaporator to provide 1.4 g of an exemplary compound 2-2 (m/z=178.1, yield: 80%).

### Exemplary Compound 3-1

0.5 mmol of 4-nitrobenzoic acid, 5 mmol of 4-aminobenzoic acid, 5 mmol of potassium hydroxide, 6 mL of methanol and 7 mL of water were loaded into a pressure-resistant glass bottle, and the bottle was sealed with an aluminum crimp cap. The mixture was stirred in an oil bath at 100° C. for 24 hours under heating and then cooled to 25° C. The solvent was removed with an evaporator and the resultant was extracted with cold methanol, followed by filtration to provide a solid. The obtained solid was dissolved in dichloromethane, 20 mL of concentrated hydrochloric acid and 20 mL of acetic anhydride were added thereto and the resultant was stirred at 25° C. for 24 hours. 100 mL of water and 50 mL of dichloromethane were loaded thereinto, and an organic layer was extracted to provide an extract. The obtained extract was purified by silica gel column chromatography to provide an exemplary compound 3-1 (m/z=270.1, yield: 37%).

### Exemplary Compound 4-1

0.18 mol of 4-aminobenzoic acid, 5 g of concentrated hydrochloric acid and 150 mL of methanol were loaded into a 300 mL recovery flask and the mixture was cooled to 0° C. while being stirred in an ice bath. 0.2 mol of sodium nitrite dissolved in 25 mL of purified water was slowly dropped thereinto and the resultant was stirred while a temperature in a vessel was suppressed to 5° C. or less to provide a beige suspension containing a diazonium salt. 0.2 mol of 4-aminobenzoic acid, 0.6 mol of sodium acetate and 300 mL of methanol were loaded into a 1 L recovery flask, and the mixture was cooled to 0° C. while being stirred in an ice bath to prepare a suspension. The suspension containing a diazonium salt prepared in advance was slowly added to the prepared suspension, and the mixture was stirred at 25° C. for 15 hours. The reaction product was subjected to suction filtration and a solid content was washed with 500 g of water and 100 g of methanol, and was then subjected to vacuum drying to provide an exemplary compound 4-1 (m/z=285.1, yield: 56%).

### Exemplary Compound 4-11

0.18 mol of 4-aminobenzoic acid, 5 g of concentrated hydrochloric acid and 150 mL of methanol were loaded into a 300 mL recovery flask and the mixture was cooled to 0° C. while being stirred in an ice bath. 0.2 mol of sodium nitrite dissolved in 25 mL of purified water was slowly dropped thereinto and the resultant was stirred while a temperature in a vessel was suppressed to 5° C. or less to provide a beige suspension containing a diazonium salt. 0.2 mol of 4-aminopyridine, 0.6 mol of sodium acetate and 300 mL of methanol were loaded into a 1 L recovery flask, and the mixture was cooled to 0° C. while being stirred in an ice bath to prepare a suspension. The suspension containing a diazonium salt prepared in advance was slowly added to the prepared suspension, and the mixture was stirred at 25° C. for 15 hours. The reaction product was subjected to suction filtration and a solid content was washed with 500 g of water and 100 g of methanol, and was then subjected to vacuum drying to provide an exemplary compound 4-11 (m/z=94.1, yield: 38%).

### Exemplary Compound 5-27

Under an argon atmosphere, 0.8 g of N,N-dimethylethylenediamine was added to a solution of 1.0 g of 4-cyanobenzoyl chloride in 20 mL of chloroform, and the mixture was stirred at 25° C. for 5 hours to perform a reaction. A component obtained by concentration with a rotary evaporator was purified by column chromatography to provide 1.3 g of an exemplary compound 5-27 (m/z=217.1, yield: 99%).

### Exemplary Compound 7-12

50 mL of tetrahydrofuran anhydride, 9.3 mmol of dimethylaminoethanethiol and 10 mmol of sodium hydride were loaded into a 300 mL recovery flask having a nitrogen line, and the mixture was stirred in an ice bath while the ice bath was maintained at 0° C. A solution obtained by dissolving 8.4 mmol of 2-bromophenanthroline in 10 mL of tetrahydrofuran anhydride was dropped thereinto, and the temperature was slowly increased to 25° C., followed by stirring for 72 hours. The solvent was removed with an evaporator and the resultant was extracted with cold methanol, followed by filtration to provide a solid. The obtained solid was dissolved in dichloromethane and was purified by silica gel column chromatography to provide an exemplary compound 7-12 (m/z=283.1, yield: 24%).

### Exemplary Compound 7-15

50 mL of tetrahydrofuran anhydride, 9.3 mmol of dimethylaminoethanethiol and 10 mmol of sodium hydride were loaded into a 300 mL recovery flask having a nitrogen line, and the mixture was stirred in an ice bath while the ice bath was maintained at 0° C. A solution obtained by dissolving 4.2 mmol of 2,9-dibromophenanthroline in 100 mL of tetrahydrofuran anhydride was dropped thereinto, and the temperature was slowly increased to 25° C., followed by stirring for 72 hours. The solvent was removed with an evaporator and the resultant was extracted with cold methanol, followed by filtration to provide a solid. The obtained solid was dissolved in dichloromethane and was purified by silica gel column chromatography to provide an exemplary compound 7-15 (m/z=386.2, yield: 15%).

### Preparation of Recovered Metal Salt

A recovered metal salt was prepared with gold recovered from a substrate serving as a raw material. A base material with gold plating was cut out, and was crushed into a size of about 5 mmx about 5 mm to provide a crushed piece for ease of chemical treatment. The obtained crushed piece was immersed in 10% dilute nitric acid for 2 hours to dissolve copper and nickel and float a gold-plated foil from the base material. After that, dilute nitric acid was passed through a filter having arranged thereon filter paper to separate the gold-plated foil. Dilute nitric acid showed a blue-green color in which copper and nickel were dissolved. Dilute nitric acid was added to the gold-plated foil on the filter paper and copper and nickel remaining on a surface of the gold-plated foil were washed out. The obtained gold-plated foil was transferred to another vessel with the filter paper, and an aqua regia solution obtained by mixing 35% hydrochloric acid and 60% nitric acid at 3:1 (volume ratio) was dropped thereinto little by little to dissolve gold. At the time when gold was dissolved, the filter paper was taken out, and the obtained gold-aqua regia solution was filtered to remove a fragment of the base material. The filtrate was distilled under reduced pressure while being warmed with an acid-resistant rotary evaporator to remove nitric acid, hydrochloric acid and water in the stated order. Thus, chloroauric(III) acid tetrahydrate was obtained.

### Production of Conductive Composition (Dispersion Liquid)

A conductive composition (dispersion liquid) was produced by the following method. The average particle diameter (volume-based 50% cumulative particle diameter, D50) of the metal particle in the produced conductive composition was measured with a small-angle X-ray scattering apparatus (product name: “Nano-Viewer”, manufactured by Rigaku Corporation). Measurement conditions at this time were set to a wavelength (X) of 0.154 nm and an incident angle of 1.7°. In addition, a zeta potential of the metal particle in the conductive composition was measured with a zeta potentiometer (product name: “Zetasizer Nano”, manufactured by Malvern). At this time, the produced conductive composition was subjected to centrifugation treatment and the supernatant was removed to provide a wet cake. After that, a sample prepared by diluting the wet cake with ultrapure water so as to have a concentration suitable for the measurement was used as a measurement target. The zeta potentials of a gold particle and a silver particle generated by reducing gold(III) chloride tetrahydrate and silver(I) nitrate (all of which are manufactured by Kishida Chemical Co., Ltd.) with trisodium citrate dihydrate were 1 mV and 0 mV, respectively.

(Conductive Composition using Gold Particle)

Chloroauric(III) acid tetrahydrate (manufactured by Kishida Chemical Co., Ltd.) in each usage amount shown in Tables 8 to 14 and 1,300 mL of ultrapure water were heated to reflux and trisodium citrate dihydrate in each usage amount shown in Tables 8 to 14 was added thereto. The internal temperature was kept at 100° C. and the resultant was stirred for 2 hours. In the tables, chloroauric(III) acid tetrahydrate and trisodium citrate dihydrate were indicated as “chloroauric(III) acid” and “citric acid”, respectively. The resultant was cooled to 25° C. and then the pH of the liquid was adjusted to 5 with 0.1 mol/L hydrochloric acid as required. 3 mmol of the treatment agent of the kind shown in Tables 8 to 14 was added thereto and the resultant was stirred for 15 hours. Thus, the respective conductive compositions were obtained. In Tables 8 to 14, in the conductive composition in which “Au (recovered)” is indicated in the column of the metal particle, gold(III) chloride tetrahydrate obtained in the “Preparation of Recovered Metal Salt” section described above was used.

(Conductive Composition using Silver Particle)

Silver(I) nitrate (manufactured by Kishida Chemical Co., Ltd.) in each usage amount shown in Tables 8 to 14 and trisodium citrate dihydrate in each usage amount shown in Tables 8 to 14 were dissolved in 1,000 mL of ultrapure water and the mixture was stirred for 30 minutes while being cooled with ice to provide an aqueous solution. A solution obtained by dissolving 33 mg of sodium borohydride to 1 g of ion-exchanged water was added to the obtained aqueous solution, followed by further cooling with ice and stirring for 30 minutes to provide a brown transparent dispersion liquid. The obtained dispersion liquid was cooled to 25° C. and then the pH of the liquid was adjusted to 3 with 0.1 mol/L hydrochloric acid as required, and 3 mmol of the treatment agent of the kind shown in Tables 8 to 14 was added thereto while stirring was performed. Further, the resultant was stirred at 25° C. for 30 minutes. Thus, the respective conductive compositions were obtained.

### (Conductive Composition D1)

A conductive composition D1 was produced by the following method (Comparative Example). The conductive composition D1 was obtained in the same manner as in the production of the conductive composition (dispersion liquid) using the gold particle described in the foregoing except that 4,5-bis[(2-N,N-dimethylaminoethyl)thio]phthalonitrile (a phthalocyanine derivative) was used as the treatment agent. The average particle diameter of the metal particle in the obtained conductive composition D1 was 20 nm and the zeta potential of the metal particle was 39 mV. 4,5-bis[(2-N,N-dimethylaminoethyl)thio]phthalonitrile was synthesized in accordance with a known method described in the following document using 4,5-dichlorophthalonitrile (manufactured by Tokyo Chemical Industry Co., Ltd.) as a raw material. Details of the conductive composition D1 are shown in Table 15.
Journal of Medicinal Chemistry, 2015, Vol. 58, No. 4, pp. 1,736-1,749

### (Conductive Composition D2)

A conductive composition D2 was produced by the following method (Comparative Example). 1 g of chloroauric(III) acid tetrahydrate (manufactured by Kishida Chemical Co., Ltd.) and 1,300 mL of ultrapure water were heated to reflux. Then, 1.75 g of trisodium citrate dihydrate was added thereto and the mixture was stirred for 2 hours. The resultant was cooled to 25° C. to provide the conductive composition D2. The average particle diameter of the metal particle in the obtained conductive composition D2 was 20 nm and the zeta potential of the metal particle was −38 mV. Details of the conductive composition D2 are shown in Table 15.

### (Conductive Composition D3)

A conductive composition D3 was produced by the following method (Comparative Example). The conductive composition D3 having the following composition was obtained in accordance with the preparation method for the “dispersion paste 4” described in “Example 4” in Japanese Patent Application Laid-Open No. 2015-076233. The zeta potential of the metal particle in the obtained conductive composition D3 was 28 mV. Details of the conductive composition D3 are shown in Table 15.
Copper fine particle: 20 parts
Copolymerized polyester: 0.875 part
n-Butyl carbitol acetate: 1.625 parts
4-(Di ethyl amino)b enzal dehyde-1, 1-diphenylhydrazone: 1 part
Ethyl carbitol acetate: 4 parts

TABLE 8
Production conditions of conductive composition (dispersion liquid) and characteristics thereof

| | | Production conditions | | | | | | Characteristics | |
|---|---|---|---|---|---|---|---|---|---|
| | | Conductive | | Treatment | | | | Average | |
| | | composition | | agent (e.g., | Metal salt | | Citric | particle | Zeta |
| | | (dispersion | Metal | exemplary | kind and usage | | acid | diameter | potential |
| | | liquid) | particle | compound) | amount (g) | | (g) | (nm) | (mV) |
| Example | D1-1 | D1-1 | Au | 1-1 | Chloroauric(III) | 1.00 | 1.75 | 19 | −90 |
| | | | | | acid | | | | |
| Example | D1-2 | D1-2 | Au | 1-2 | Chloroauric(III) | 1.00 | 1.75 | 19 | −91 |
| | | | | | acid | | | | |
| Example | D1-3 | D1-3 | Au | 1-3 | Chloroauric(III) | 1.00 | 1.75 | 22 | −92 |
| | | | | | acid | | | | |
| Example | D1-4 | D1-4 | Au | 1-6 | Chloroauric(III) | 1.00 | 1.75 | 21 | −88 |
| | | | | | acid | | | | |
| Example | D1-5 | D1-5 | Au | 1-7 | Chloroauric(III) | 1.00 | 1.75 | 20 | −81 |
| | | | | | acid | | | | |
| Example | D1-6 | D1-6 | Au | 1-8 | Chloroauric(III) | 1.00 | 1.75 | 23 | −90 |
| | | | | | acid | | | | |
| Example | D1-7 | D1-7 | Au | 1-9 | Chloroauric(III) | 1.00 | 1.75 | 21 | 83 |
| | | | | | acid | | | | |
| Example | D1-8 | D1-8 | Au | 1-10 | Chloroauric(III) | 1.00 | 1.75 | 20 | 85 |
| | | | | | acid | | | | |
| Example | D1-9 | D1-9 | Au | 1-11 | Chloroauric(III) | 1.00 | 1.75 | 21 | 86 |
| | | | | | acid | | | | |
| Example | D1-10 | D1-10 | Au | 1-12 | Chloroauric(III) | 1.00 | 1.75 | 22 | 88 |
| | | | | | acid | | | | |
| Example | D1-11 | D1-11 | Au | 1-13 | Chloroauric(III) | 1.00 | 1.75 | 20 | 89 |
| | | | | | acid | | | | |
| Example | D1-12 | D1-12 | Au | 1-14 | Chloroauric(III) | 1.00 | 1.75 | 23 | 90 |
| | | | | | acid | | | | |
| Example | D1-13 | D1-13 | Au | 1-22 | Chloroauric(III) | 1.00 | 1.75 | 20 | −82 |
| | | | | | acid | | | | |
| Example | D1-14 | D1-14 | Au | 1-23 | Chloroauric(III) | 1.00 | 1.75 | 21 | 83 |
| | | | | | acid | | | | |
| Example | D1-15 | D1-15 | Au | 1-24 | Chloroauric(III) | 1.00 | 1.75 | 19 | −88 |
| | | | | | acid | | | | |
| Example | D1-16 | D1-16 | Au | 1-27 | Chloroauric(III) | 1.00 | 1.75 | 19 | −90 |
| | | | | | acid | | | | |
| Example | D1-17 | D1-17 | Au | 1-28 | Chloroauric(III) | 1.00 | 1.75 | 20 | −81 |
| | | | | | acid | | | | |
| Example | D1-18 | D1-18 | Au | 1-38 | Chloroauric(III) | 1.00 | 1.75 | 20 | −78 |
| | | | | | acid | | | | |
| Example | D1-19 | D1-19 | Au | 1-39 | Chloroauric(III) | 1.00 | 1.75 | 22 | 90 |
| | | | | | acid | | | | |
| Example | D1-20 | D1-20 | Au | 1-40 | Chloroauric(III) | 1.00 | 1.75 | 20 | 89 |
| | | | | | acid | | | | |
| Example | D1-21 | D1-21 | Au | 1-41 | Chloroauric(III) | 1.00 | 1.75 | 22 | 85 |
| | | | | | acid | | | | |
| Example | D1-22 | D1-22 | Au | 1-42 | Chloroauric(III) | 1.00 | 1.75 | 21 | 87 |
| | | | | | acid | | | | |
| Example | D1-23 | D1-23 | Au | 1-43 | Chloroauric(III) | 1.00 | 1.75 | 20 | 85 |
| | | | | | acid | | | | |
| Example | D1-24 | D1-24 | Au | 1-49 | Chloroauric(III) | 1.00 | 1.75 | 20 | −77 |
| | | | | | acid | | | | |
| Example | D1-25 | D1-25 | Au | 1-57 | Chloroauric(III) | 1.00 | 1.75 | 19 | −81 |
| | | | | | acid | | | | |
| Example | D1-26 | D1-26 | Au | 1-58 | Chloroauric(III) | 1.00 | 1.75 | 20 | −93 |
| | | | | | acid | | | | |
| Example | D1-27 | D1-27 | Au | 1-64 | Chloroauric(III) | 1.00 | 1.75 | 21 | 75 |
| | | | | | acid | | | | |
| Example | D1-28 | D1-28 | Au | 1-68 | Chloroauric(III) | 1.00 | 1.75 | 23 | −74 |
| | | | | | acid | | | | |
| Example | D1-29 | D1-29 | Au | 1-77 | Chloroauric(III) | 1.00 | 1.75 | 25 | −80 |
| | | | | | acid | | | | |
| Example | D1-30 | D1-30 | Ag | 1-1 | Silver(I) nitrate | 0.10 | 0.40 | 22 | −81 |
| Example | D1-31 | D1-31 | Au | 1-1 | Chloroauric(III) | 1.00 | 1.86 | 1 | −35 |
| | | | | | acid | | | | |
| Example | D1-32 | D1-32 | Au | 1-1 | Chloroauric(III) | 1.00 | 1.81 | 5 | −88 |
| | | | | | acid | | | | |
| Example | D1-33 | D1-33 | Au | 1-1 | Chloroauric(III) | 1.00 | 0.58 | 100 | −82 |
| | | | | | acid | | | | |
| Example | D1-34 | D1-34 | Au | 1-1 | Chloroauric(III) | 1.00 | 0.27 | 120 | −35 |
| | | | | | acid | | | | |
| Example | D1-35 | D1-35 | Au | 1-1 | Chloroauric(III) | 1.00 | 1.75 | 21 | −93 |
| | | | (recovered) | | acid | | | | |

TABLE 9
Production conditions of conductive composition (dispersion liquid) and characteristics thereof

| | | Production conditions | | | | | | Characteristics | |
|---|---|---|---|---|---|---|---|---|---|
| | | Conductive | | Treatment | | | | Average | |
| | | composition | | agent (e.g., | Metal salt | | Citric | particle | Zeta |
| | | (dispersion | Metal | exemplary | kind and usage | | acid | diameter | potential |
| | | liquid) | particle | compound) | amount (g) | | (g) | (nm) | (mV) |
| Example | D2-1 | D2-1 | Au | 2-1 | Chloroauric(III) | 1.00 | 1.75 | 19 | −94 |
| | | | | | acid | | | | |
| Example | D2-2 | D2-2 | Au | 2-2 | Chloroauric(III) | 1.00 | 1.75 | 19 | −92 |
| | | | | | acid | | | | |
| Example | D2-3 | D2-3 | Au | 2-3 | Chloroauric(III) | 1.00 | 1.75 | 20 | −94 |
| | | | | | acid | | | | |
| Example | D2-4 | D2-4 | Au | 2-4 | Chloroauric(III) | 1.00 | 1.75 | 21 | −93 |
| | | | | | acid | | | | |
| Example | D2-5 | D2-5 | Au | 2-5 | Chloroauric(III) | 1.00 | 1.75 | 20 | −92 |
| | | | | | acid | | | | |
| Example | D2-6 | D2-6 | Au | 2-9 | Chloroauric(III) | 1.00 | 1.75 | 21 | 91 |
| | | | | | acid | | | | |
| Example | D2-7 | D2-7 | Au | 2-10 | Chloroauric(III) | 1.00 | 1.75 | 20 | 92 |
| | | | | | acid | | | | |
| Example | D2-8 | D2-8 | Au | 2-11 | Chloroauric(III) | 1.00 | 1.75 | 22 | 90 |
| | | | | | acid | | | | |
| Example | D2-9 | D2-9 | Au | 2-12 | Chloroauric(III) | 1.00 | 1.75 | 20 | 95 |
| | | | | | acid | | | | |
| Example | D2-10 | D2-10 | Au | 2-13 | Chloroauric(III) | 1.00 | 1.75 | 21 | 92 |
| | | | | | acid | | | | |
| Example | D2-11 | D2-11 | Au | 2-14 | Chloroauric(III) | 1.00 | 1.75 | 20 | 94 |
| | | | | | acid | | | | |
| Example | D2-12 | D2-12 | Au | 2-18 | Chloroauric(III) | 1.00 | 1.75 | 21 | 90 |
| | | | | | acid | | | | |
| Example | D2-13 | D2-13 | Au | 2-19 | Chloroauric(III) | 1.00 | 1.75 | 20 | 90 |
| | | | | | acid | | | | |
| Example | D2-14 | D2-14 | Au | 2-22 | Chloroauric(III) | 1.00 | 1.75 | 21 | −94 |
| | | | | | acid | | | | |
| Example | D2-15 | D2-15 | Au | 2-23 | Chloroauric(III) | 1.00 | 1.75 | 21 | 92 |
| | | | | | acid | | | | |
| Example | D2-16 | D2-16 | Au | 2-29 | Chloroauric(III) | 1.00 | 1.75 | 22 | −88 |
| | | | | | acid | | | | |
| Example | D2-17 | D2-17 | Au | 2-30 | Chloroauric(III) | 1.00 | 1.75 | 20 | −90 |
| | | | | | acid | | | | |
| Example | D2-18 | D2-18 | Au | 2-31 | Chloroauric(III) | 1.00 | 1.75 | 20 | −89 |
| | | | | | acid | | | | |
| Example | D2-19 | D2-19 | Au | 2-38 | Chloroauric(III) | 1.00 | 1.75 | 21 | −90 |
| | | | | | acid | | | | |
| Example | D2-20 | D2-20 | Au | 2-39 | Chloroauric(III) | 1.00 | 1.75 | 21 | 90 |
| | | | | | acid | | | | |
| Example | D2-21 | D2-21 | Au | 2-40 | Chloroauric(III) | 1.00 | 1.75 | 20 | 91 |
| | | | | | acid | | | | |
| Example | D2-22 | D2-22 | Au | 2-47 | Chloroauric(III) | 1.00 | 1.75 | 20 | −92 |
| | | | | | acid | | | | |
| Example | D2-23 | D2-23 | Au | 2-51 | Chloroauric(III) | 1.00 | 1.75 | 20 | 81 |
| | | | | | acid | | | | |
| Example | D2-24 | D2-24 | Au | 2-59 | Chloroauric(III) | 1.00 | 1.75 | 19 | −83 |
| | | | | | acid | | | | |
| Example | D2-25 | D2-25 | Au | 2-62 | Chloroauric(III) | 1.00 | 1.75 | 20 | 75 |
| | | | | | acid | | | | |
| Example | D2-26 | D2-26 | Au | 2-74 | Chloroauric(III) | 1.00 | 1.75 | 20 | 78 |
| | | | | | acid | | | | |
| Example | D2-27 | D2-27 | Au | 2-78 | Chloroauric(III) | 1.00 | 1.75 | 19 | −78 |
| | | | | | acid | | | | |
| Example | D2-28 | D2-28 | Au | 2-87 | Chloroauric(III) | 1.00 | 1.75 | 20 | −84 |
| | | | | | acid | | | | |
| Example | D2-29 | D2-29 | Au | 2-88 | Chloroauric(III) | 1.00 | 1.75 | 20 | −89 |
| | | | | | acid | | | | |
| Example | D2-30 | D2-30 | Au | 2-97 | Chloroauric(III) | 1.00 | 1.75 | 21 | −86 |
| | | | | | acid | | | | |
| Example | D2-31 | D2-31 | Au | 2-98 | Chloroauric(III) | 1.00 | 1.75 | 20 | −88 |
| | | | | | acid | | | | |
| Example | D2-32 | D2-32 | Au | 2-111 | Chloroauric(III) | 1.00 | 1.75 | 20 | 79 |
| | | | | | acid | | | | |
| Example | D2-33 | D2-33 | Au | 2-112 | Chloroauric(III) | 1.00 | 1.75 | 19 | 81 |
| | | | | | acid | | | | |
| Example | D2-34 | D2-34 | Au | 2-118 | Chloroauric(III) | 1.00 | 1.75 | 20 | −85 |
| | | | | | acid | | | | |
| Example | D2-35 | D2-35 | Au | 2-129 | Chloroauric(III) | 1.00 | 1.75 | 20 | −79 |
| | | | | | acid | | | | |
| Example | D2-36 | D2-36 | Au | 2-139 | Chloroauric(III) | 1.00 | 1.75 | 19 | −80 |
| | | | | | acid | | | | |
| Example | D2-37 | D2-37 | Ag | 2-1 | Silver(I) nitrate | 0.10 | 0.40 | 23 | −76 |
| Example | D2-38 | D2-38 | Au | 2-1 | Chloroauric(III) | 1.00 | 1.86 | 1 | −35 |
| | | | | | acid | | | | |
| Example | D2-39 | D2-39 | Au | 2-1 | Chloroauric(III) | 1.00 | 1.81 | 5 | −78 |
| | | | | | acid | | | | |
| Example | D2-40 | D2-40 | Au | 2-1 | Chloroauric(III) | 1.00 | 0.58 | 100 | −72 |
| | | | | | acid | | | | |
| Example | D2-41 | D2-41 | Au | 2-1 | Chloroauric(III) | 1.00 | 0.27 | 120 | −36 |
| | | | | | acid | | | | |
| Example | D2-42 | D2-42 | Au | 2-1 | Chloroauric(III) | 1.00 | 1.75 | 20 | −88 |
| | | | (recovered) | | acid | | | | |

TABLE 10
Production conditions of conductive composition (dispersion liquid) and characteristics thereof

| | | Production conditions | | | | | | Characteristics | |
|---|---|---|---|---|---|---|---|---|---|
| | | Conductive | | Treatment | | | | Average | |
| | | composition | | agent (e.g., | Metal salt | | Citric | particle | Zeta |
| | | (dispersion | Metal | exemplary | kind and usage | | acid | diameter | potential |
| | | liquid) | particle | compound) | amount (g) | | (g) | (nm) | (mV) |
| Example | D3-1 | D3-1 | Au | 3-1 | Chloroauric(III) | 1.00 | 1.16 | 20 | −51 |
| | | | | | acid | | | | |
| Example | D3-2 | D3-2 | Au | 3-2 | Chloroauric(III) | 1.00 | 1.16 | 23 | −51 |
| | | | | | acid | | | | |
| Example | D3-3 | D3-3 | Au | 3-3 | Chloroauric(III) | 1.00 | 1.16 | 22 | −46 |
| | | | | | acid | | | | |
| Example | D3-4 | D3-4 | Au | 3-4 | Chloroauric(III) | 1.00 | 1.16 | 21 | −48 |
| | | | | | acid | | | | |
| Example | D3-5 | D3-5 | Au | 3-5 | Chloroauric(III) | 1.00 | 1.16 | 23 | −48 |
| | | | | | acid | | | | |
| Example | D3-6 | D3-6 | Au | 3-6 | Chloroauric(III) | 1.00 | 1.16 | 19 | 48 |
| | | | | | acid | | | | |
| Example | D3-7 | D3-7 | Au | 3-7 | Chloroauric(III) | 1.00 | 1.16 | 20 | 44 |
| | | | | | acid | | | | |
| Example | D3-8 | D3-8 | Au | 3-8 | Chloroauric(III) | 1.00 | 1.16 | 22 | 45 |
| | | | | | acid | | | | |
| Example | D3-9 | D3-9 | Au | 3-9 | Chloroauric(III) | 1.00 | 1.16 | 21 | −45 |
| | | | | | acid | | | | |
| Example | D3-10 | D3-10 | Au | 3-10 | Chloroauric(III) | 1.00 | 1.16 | 20 | −49 |
| | | | | | acid | | | | |
| Example | D3-11 | D3-11 | Au | 3-11 | Chloroauric(III) | 1.00 | 1.16 | 23 | 41 |
| | | | | | acid | | | | |
| Example | D3-12 | D3-12 | Au | 3-12 | Chloroauric(III) | 1.00 | 1.16 | 19 | −44 |
| | | | | | acid | | | | |
| Example | D3-13 | D3-13 | Au | 3-13 | Chloroauric(III) | 1.00 | 1.16 | 20 | −53 |
| | | | | | acid | | | | |
| Example | D3-14 | D3-14 | Au | 3-14 | Chloroauric(III) | 1.00 | 1.16 | 22 | −55 |
| | | | | | acid | | | | |
| Example | D3-15 | D3-15 | Au | 3-15 | Chloroauric(III) | 1.00 | 1.16 | 21 | −54 |
| | | | | | acid | | | | |
| Example | D3-16 | D3-16 | Au | 3-16 | Chloroauric(III) | 1.00 | 1.16 | 22 | 51 |
| | | | | | acid | | | | |
| Example | D3-17 | D3-17 | Ag | 3-1 | Silver(I) nitrate | 0.10 | 0.40 | 23 | −42 |
| Example | D3-18 | D3-18 | Au | 3-1 | Chloroauric(III) | 1.00 | 1.30 | 1 | −29 |
| | | | | | acid | | | | |
| Example | D3-19 | D3-19 | Au | 3-1 | Chloroauric(III) | 1.00 | 1.27 | 5 | −53 |
| | | | | | acid | | | | |
| Example | D3-20 | D3-20 | Au | 3-1 | Chloroauric(III) | 1.00 | 0.58 | 100 | −42 |
| | | | | | acid | | | | |
| Example | D3-21 | D3-21 | Au | 3-1 | Chloroauric(III) | 1.00 | 0.43 | 120 | −28 |
| | | | | | acid | | | | |
| Example | D3-22 | D3-22 | Au | 3-1 | Chloroauric(III) | 1.00 | 1.16 | 20 | −50 |
| | | | (recovered) | | acid | | | | |

TABLE 11
Production conditions of conductive composition (dispersion liquid) and characteristics thereof

| | | Production conditions | | | | | | Characteristics | |
|---|---|---|---|---|---|---|---|---|---|
| | | Conductive | | Treatment | | | | Average | |
| | | composition | | agent (e.g., | Metal salt | | Citric | particle | Zeta |
| | | (dispersion | Metal | exemplary | kind and usage | | acid | diameter | potential |
| | | liquid) | particle | compound) | amount (g) | | (g) | (nm) | (mV) |
| Example | D4-1 | D4-1 | Au | 4-1 | Chloroauric(III) | 1.00 | 1.16 | 21 | −50 |
| | | | | | acid | | | | |
| Example | D4-2 | D4-2 | Au | 4-2 | Chloroauric(III) | 1.00 | 1.16 | 19 | −50 |
| | | | | | acid | | | | |
| Example | D4-3 | D4-3 | Au | 4-3 | Chloroauric(III) | 1.00 | 1.16 | 23 | −48 |
| | | | | | acid | | | | |
| Example | D4-4 | D4-4 | Au | 4-4 | Chloroauric(III) | 1.00 | 1.16 | 22 | −46 |
| | | | | | acid | | | | |
| Example | D4-5 | D4-5 | Au | 4-5 | Chloroauric(III) | 1.00 | 1.16 | 21 | −46 |
| | | | | | acid | | | | |
| Example | D4-6 | D4-6 | Au | 4-6 | Chloroauric(III) | 1.00 | 1.16 | 22 | 50 |
| | | | | | acid | | | | |
| Example | D4-7 | D4-7 | Au | 4-7 | Chloroauric(III) | 1.00 | 1.16 | 23 | 47 |
| | | | | | acid | | | | |
| Example | D4-8 | D4-8 | Au | 4-8 | Chloroauric(III) | 1.00 | 1.16 | 23 | 48 |
| | | | | | acic | | | | |
| Example | D4-9 | D4-9 | Au | 4-9 | Chloroauric(III) | 1.00 | 1.16 | 20 | −45 |
| | | | | | acid | | | | |
| Example | D4-10 | D4-10 | Au | 4-10 | Chloroauric(III) | 1.00 | 1.16 | 21 | −49 |
| | | | | | acid | | | | |
| Example | D4-11 | D4-11 | Au | 4-11 | Chloroauric(III) | 1.00 | 1.16 | 22 | 51 |
| | | | | | acid | | | | |
| Example | D4-12 | D4-12 | Au | 4-12 | Chloroauric(III) | 1.00 | 1.16 | 22 | −44 |
| | | | | | acid | | | | |
| Example | D4-13 | D4-13 | Au | 4-13 | Chloroauric(III) | 1.00 | 1.16 | 22 | −43 |
| | | | | | acid | | | | |
| Example | D4-14 | D4-14 | Au | 4-14 | Chloroauric(III) | 1.00 | 1.16 | 20 | −53 |
| | | | | | acid | | | | |
| Example | D4-15 | D4-15 | Au | 4-15 | Chloroauric(III) | 1.00 | 1.16 | 21 | −55 |
| | | | | | acid | | | | |
| Example | D4-16 | D4-16 | Au | 4-16 | Chloroauric(III) | 1.00 | 1.16 | 20 | −53 |
| | | | | | acid | | | | |
| Example | D4-17 | D4-17 | Au | 4-17 | Chloroauric(III) | 1.00 | 1.16 | 20 | 53 |
| | | | | | acid | | | | |
| Example | D4-18 | D4-18 | Ag | 4-11 | Silver(I) nitrate | 0.10 | 0.40 | 23 | 42 |
| Example | D4-19 | D4-19 | Au | 4-11 | Chloroauric(III) | 1.00 | 1.30 | 1 | 25 |
| | | | | | acid | | | | |
| Example | D4-20 | D4-20 | Au | 4-11 | Chloroauric(III) | 1.00 | 1.27 | 5 | 54 |
| | | | | | acid | | | | |
| Example | D4-21 | D4-21 | Au | 4-11 | Chloroauric(III) | 1.00 | 0.58 | 100 | 43 |
| | | | | | acid | | | | |
| Example | D4-22 | D4-22 | Au | 4-11 | Chloroauric(III) | 1.00 | 0.43 | 120 | 28 |
| | | | | | acid | | | | |
| Example | D4-23 | D4-23 | Au | 4-11 | Chloroauric(III) | 1.00 | 1.16 | 20 | 51 |
| | | | (recovered) | | acid | | | | |

TABLE 12
Production conditions of conductive composition (dispersion liquid) and characteristics thereof

| | | Production conditions | | | | | | Characteristics | |
|---|---|---|---|---|---|---|---|---|---|
| | | Conductive | | Treatment | | | | Average | |
| | | composition | | agent (e.g., | Metal salt | | Citric | particle | Zeta |
| | | (dispersion | Metal | exemplary | kind and usage | | acid | diameter | potential |
| | | liquid) | particle | compound) | amount (g) | | (g) | (nm) | (mV) |
| Example | D5-1 | D5-1 | Au | 5-1 | Chloroauric(III) | 1.00 | 1.75 | 20 | −54 |
| | | | | | acid | | | | |
| Example | D5-2 | D5-2 | Au | 5-2 | Chloroauric(III) | 1.00 | 1.75 | 20 | −51 |
| | | | | | acid | | | | |
| Example | D5-3 | D5-3 | Au | 5-3 | Chloroauric(III) | 1.00 | 1.75 | 22 | −52 |
| | | | | | acid | | | | |
| Example | D5-4 | D5-4 | Au | 5-4 | Chloroauric(III) | 1.00 | 1.75 | 21 | −54 |
| | | | | | acid | | | | |
| Example | D5-5 | D5-5 | Au | 5-5 | Chloroauric(III) | 1.00 | 1.75 | 20 | −52 |
| | | | | | acid | | | | |
| Example | D5-6 | D5-6 | Au | 5-6 | Chloroauric(III) | 1.00 | 1.75 | 22 | −51 |
| | | | | | acid | | | | |
| Example | D5-7 | D5-7 | Au | 5-7 | Chloroauric(III) | 1.00 | 1.75 | 21 | −51 |
| | | | | | acid | | | | |
| Example | D5-8 | D5-8 | Au | 5-8 | Chloroauric(III) | 1.00 | 1.75 | 20 | −52 |
| | | | | | acid | | | | |
| Example | D5-9 | D5-9 | Au | 5-9 | Chloroauric(III) | 1.00 | 1.75 | 21 | 51 |
| | | | | | acid | | | | |
| Example | D5-10 | D5-10 | Au | 5-10 | Chloroauric(III) | 1.00 | 1.75 | 22 | 50 |
| | | | | | acid | | | | |
| Example | D5-11 | D5-11 | Au | 5-11 | Chloroauric(III) | 1.00 | 1.75 | 20 | 52 |
| | | | | | acid | | | | |
| Example | D5-12 | D5-12 | Au | 5-12 | Chloroauric(III) | 1.00 | 1.75 | 23 | 49 |
| | | | | | acid | | | | |
| Example | D5-13 | D5-13 | Au | 5-13 | Chloroauric(III) | 1.00 | 1.75 | 20 | 52 |
| | | | | | acid | | | | |
| Example | D5-14 | D5-14 | Au | 5-14 | Chloroauric(III) | 1.00 | 1.75 | 21 | 51 |
| | | | | | acid | | | | |
| Example | D5-15 | D5-15 | Au | 5-17 | Chloroauric(III) | 1.00 | 1.75 | 19 | −54 |
| | | | | | acid | | | | |
| Example | D5-16 | D5-16 | Au | 5-19 | Chloroauric(III) | 1.00 | 1.75 | 19 | 54 |
| | | | | | acid | | | | |
| Example | D5-17 | D5-17 | Au | 5-25 | Chloroauric(III) | 1.00 | 1.75 | 20 | 51 |
| | | | | | acid | | | | |
| Example | D5-18 | D5-18 | Au | 5-27 | Chloroauric(III) | 1.00 | 1.75 | 20 | 48 |
| | | | | | acid | | | | |
| Example | D5-19 | D5-19 | Au | 5-29 | Chloroauric(III) | 1.00 | 1.75 | 22 | −50 |
| | | | | | acid | | | | |
| Example | D5-20 | D5-20 | Au | 5-30 | Chloroauric(III) | 1.00 | 1.75 | 20 | 50 |
| | | | | | acid | | | | |
| Example | D5-21 | D5-21 | Ag | 5-13 | Silver(I) nitrate | 0.10 | 0.40 | 22 | 48 |
| Example | D5-22 | D5-22 | Au | 5-13 | Chloroauric(III) | 1.00 | 1.87 | 1 | 38 |
| | | | | | acid | | | | |
| Example | D5-23 | D5-23 | Au | 5-13 | Chloroauric(III) | 1.00 | 1.81 | 5 | 42 |
| | | | | | acid | | | | |
| Example | D5-24 | D5-24 | Au | 5-13 | Chloroauric(III) | 1.00 | 0.58 | 100 | 41 |
| | | | | | acid | | | | |
| Example | D5-25 | D5-25 | Au | 5-13 | Chloroauric(III) | 1.00 | 0.26 | 120 | 35 |
| | | | | | acid | | | | |
| Example | D5-26 | D5-26 | Au | 5-13 | Chloroauric(III) | 1.00 | 1.75 | 21 | 51 |
| | | | (recovered) | | acid | | | | |

TABLE 13
Production conditions of conductive composition (dispersion liquid) and characteristics thereof

| | | Production conditions | | | | | | Characteristics | |
|---|---|---|---|---|---|---|---|---|---|
| | | Conductive | | Treatment | | | | Average | |
| | | composition | | agent (e.g., | Metal salt | | Citric | particle | Zeta |
| | | (dispersion | Metal | exemplary | kind and usage | | acid | diameter | potential |
| | | liquid) | particle | compound) | amount (g) | | (g) | (nm) | (mV) |
| Example | D6-1 | D6-1 | Au | 6-1 | Chloroauric(III) | 1.00 | 1.16 | 20 | −63 |
| | | | | | acid | | | | |
| Example | D6-2 | D6-2 | Au | 6-2 | Chloroauric(III) | 1.00 | 1.16 | 21 | −63 |
| | | | | | acid | | | | |
| Example | D6-3 | D6-3 | Au | 6-3 | Chloroauric(III) | 1.00 | 1.16 | 23 | −64 |
| | | | | | acid | | | | |
| Example | D6-4 | D6-4 | Au | 6-4 | Chloroauric(III) | 1.00 | 1.16 | 20 | −65 |
| | | | | | acid | | | | |
| Example | D6-5 | D6-5 | Au | 6-5 | Chloroauric(III) | 1.00 | 1.16 | 20 | −65 |
| | | | | | acid | | | | |
| Example | D6-6 | D6-6 | Au | 6-6 | Chloroauric(III) | 1.00 | 1.16 | 19 | −66 |
| | | | | | acid | | | | |
| Example | D6-7 | D6-7 | Au | 6-8 | Chloroauric(III) | 1.00 | 1.16 | 21 | −69 |
| | | | | | acid | | | | |
| Example | D6-8 | D6-8 | Au | 6-9 | Chloroauric(III) | 1.00 | 1.16 | 22 | −62 |
| | | | | | acid | | | | |
| Example | D6-9 | D6-9 | Au | 6-12 | Chloroauric(III) | 1.00 | 1.16 | 23 | −62 |
| | | | | | acid | | | | |
| Example | D6-10 | D6-10 | Au | 6-13 | Chloroauric(III) | 1.00 | 1.16 | 23 | −64 |
| | | | | | acid | | | | |
| Example | D6-11 | D6-11 | Au | 6-14 | Chloroauric(III) | 1.00 | 1.16 | 21 | −65 |
| | | | | | acid | | | | |
| Example | D6-12 | D6-12 | Au | 6-15 | Chloroauric(III) | 1.00 | 1.16 | 20 | −70 |
| | | | | | acid | | | | |
| Example | D6-13 | D6-13 | Au | 6-16 | Chloroauric(III) | 1.00 | 1.16 | 20 | −64 |
| | | | | | acid | | | | |
| Example | D6-14 | D6-14 | Au | 6-17 | Chloroauric(III) | 1.00 | 1.16 | 23 | −61 |
| | | | | | acid | | | | |
| Example | D6-15 | D6-15 | Au | 6-18 | Chloroauric(III) | 1.00 | 1.16 | 22 | −62 |
| | | | | | acid | | | | |
| Example | D6-16 | D6-16 | Au | 6-19 | Chloroauric(III) | 1.00 | 1.16 | 19 | −63 |
| | | | | | acid | | | | |
| Example | D6-17 | D6-17 | Au | 6-20 | Chloroauric(III) | 1.00 | 1.16 | 20 | −65 |
| | | | | | acid | | | | |
| Example | D6-18 | D6-18 | Au | 6-21 | Chloroauric(III) | 1.00 | 1.16 | 21 | 60 |
| | | | | | acid | | | | |
| Example | D6-19 | D6-19 | Au | 6-23 | Chloroauric(III) | 1.00 | 1.16 | 20 | 68 |
| | | | | | acid | | | | |
| Example | D6-20 | D6-20 | Au | 6-25 | Chloroauric(III) | 1.00 | 1.16 | 21 | 64 |
| | | | | | acid | | | | |
| Example | D6-21 | D6-21 | Au | 6-26 | Chloroauric(III) | 1.00 | 1.16 | 22 | 62 |
| | | | | | acid | | | | |
| Example | D6-22 | D6-22 | Au | 6-27 | Chloroauric(III) | 1.00 | 1.16 | 21 | −65 |
| | | | | | acid | | | | |
| Example | D6-23 | D6-23 | Ag | 6-1 | Silver(I) nitrate | 0.10 | 0.40 | 23 | −58 |
| Example | D6-24 | D6-24 | Au | 6-1 | Chloroauric(III) | 1.00 | 1.30 | 1 | −30 |
| | | | | | acid | | | | |
| Example | D6-25 | D6-25 | Au | 6-1 | Chloroauric(III) | 1.00 | 1.27 | 5 | −68 |
| | | | | | acid | | | | |
| Example | D6-26 | D6-26 | Au | 6-1 | Chloroauric(III) | 1.00 | 0.58 | 100 | −58 |
| | | | | | acid | | | | |
| Example | D6-27 | D6-27 | Au | 6-1 | Chloroauric(III) | 1.00 | 0.43 | 120 | −29 |
| | | | | | acid | | | | |
| Example | D6-28 | D6-28 | Au | 6-1 | Chloroauric(III) | 1.00 | 1.16 | 20 | −64 |
| | | | (recovered) | | acid | | | | |

TABLE 14
Production conditions of conductive composition (dispersion liquid) and characteristics thereof

| | | Production conditions | | | | | | Characteristics | |
|---|---|---|---|---|---|---|---|---|---|
| | | Conductive | | Treatment | | | | Average | |
| | | composition | | agent (e.g., | Metal salt | | Citric | particle | Zeta |
| | | (dispersion | Metal | exemplary | kind and usage | | acid | diameter | potential |
| | | liquid) | particle | compound) | amount (g) | | (g) | (nm) | (mV) |
| Example | D7-1 | D7-1 | Au | 7-3 | Chloroauric(III) | 1.00 | 1.16 | 21 | −63 |
| | | | | | acid | | | | |
| Example | D7-2 | D7-2 | Au | 7-5 | Chloroauric(III) | 1.00 | 1.16 | 20 | −62 |
| | | | | | acid | | | | |
| Example | D7-3 | D7-3 | Au | 7-7 | Chloroauric(III) | 1.00 | 1.16 | 20 | −63 |
| | | | | | acid | | | | |
| Example | D7-4 | D7-4 | Au | 7-10 | Chloroauric(III) | 1.00 | 1.16 | 20 | −61 |
| | | | | | acid | | | | |
| Example | D7-5 | D7-5 | Au | 7-12 | Chloroauric(III) | 1.00 | 1.16 | 21 | 64 |
| | | | | | acid | | | | |
| Example | D7-6 | D7-6 | Au | 7-15 | Chloroauric(III) | 1.00 | 1.16 | 20 | 64 |
| | | | | | acid | | | | |
| Example | D7-7 | D7-7 | Ag | 7-12 | Silver(I) nitrate | 0.10 | 0.40 | 24 | 67 |
| Example | D7-8 | D7-8 | Au | 7-12 | Chloroauric(III) | 1.00 | 1.30 | 1 | 29 |
| | | | | | acid | | | | |
| Example | D7-9 | D7-9 | Au | 7-12 | Chloroauric(III) | 1.00 | 1.27 | 5 | 69 |
| | | | | | acid | | | | |
| Example | D7-10 | D7-10 | Au | 7-12 | Chloroauric(III) | 1.00 | 0.58 | 100 | 58 |
| | | | | | acid | | | | |
| Example | D7-11 | D7-11 | Au | 7-12 | Chloroauric(III) | 1.00 | 0.43 | 120 | 27 |
| | | | | | acid | | | | |
| Example | D7-12 | D7-12 | Au | 7-12 | Chloroauric(III) | 1.00 | 1.16 | 20 | 64 |
| | | | (recovered) | | acid | | | | |

TABLE 15
Production conditions of conductive compound (dispersion liquid) and characteristics thereof

| | | Production conditions | | | | | | Characteristics | |
|---|---|---|---|---|---|---|---|---|---|
| | | Conductive | | | | | | Average | |
| | | composition | | Treatment agent | Metal salt | | Citric | particle | Zeta |
| | | (dispersion | Metal | (e.g., exemplary | kind and usage | | acid | diameter | potential |
| | | liquid) | particle | compound) | amount (g) | | (g) | (nm) | (mV) |
| Comparative | D1 | D1 | Au | Phthalocyanine | Chloroauric | 1.00 | 1.75 | 20 | 39 |
| Example | | | | derivative | (III) acid | | | | |
| Comparative | D2 | D2 | Au | Citric acid | Chloroauric | 1.00 | 1.75 | 20 | −38 |
| Example | | | | | (III) acid | | | | |
| Comparative | D3 | D3 | Cu | 4- | — | — | — | — | 28 |
| Example | | | | (Diethylamino)benz | | | | | |
| | | | | aldehyde-1,1- | | | | | |
| | | | | diphenylhydrazone | | | | | |

### Production of Conductive Composition (Ink)

An aqueous ink (conductive composition) including an aqueous medium and a surfactant was produced using each conductive composition (dispersion liquid) prepared in the foregoing by the following method. The average particle diameter of the metal particle in each of the obtained inks fell within the range of ±1 nm of the average particle diameter of the metal particle in the conductive composition (dispersion liquid) used as a raw material. From this fact, it was found that the metal particle was stably dispersed in each of the conductive composition (dispersion liquid) and the ink.

The respective conductive compositions (dispersion liquids) were each subjected to centrifugation treatment with a centrifuge (product name: “CR22N”, manufactured by Eppendorf Himac Technologies Co., Ltd.) under conditions of 8,000 rpm and 30 minutes and the supernatant was removed. Thus, a concentrate was obtained. The following respective components containing 10.0 parts of the concentrate (an amount in which the content of the metal particle in the ink became 10.0%) were mixed to provide the respective inks. An acetylene glycol-based surfactant (product name: “OLFINE PD-005”, manufactured by Nissin Chemical Co., Ltd.) was used as the surfactant. EG and BDO as the water-soluble organic solvent in Tables 16 to 23 represent ethylene glycol and 1,3-butanediol, respectively.
Concentrate of conductive composition (whose kind is shown in the left side of Tables 16 to 23): 10.0 parts
Water-soluble organic solvent (whose kind is shown in the left side of Tables 16 to 23): 20.0 parts
Surfactant: 0.1 part
Ultrapure water: 69.9 parts

### Production of Conductive Image

The ink (conductive composition) was loaded into an ink cartridge and set in an ink jet recording apparatus including a recording head of an ejection system shown in the middle of Tables 16 to 23. In this Example, the recording duty of a solid image recorded by applying eight ink droplets having a volume of 2.5 pL per droplet to a unit region measuring 1/600 inch by 1/600 inch is defined as “100%”. The ink jet recording apparatus was used to record a solid image measuring 2 mm by 3 cm and having a recording duty of 100% on the base material shown in the middle of Tables 16 to 23 under an environment of a temperature of 25° C. and a relative humidity of 50%. Thus, a recorded product was obtained. The obtained recorded product was dried under conditions of a drying temperature and a drying time shown in the middle of Tables 16 to 23. Thus, the respective conductive images were obtained.

Details of the ejection system shown in Tables 16 to 23 and the ink jet recording apparatus used for ejection of the ejection system are each shown below.
Thermal: a system of ejecting an ink from a recording head through the action of thermal energy and an ink jet recording apparatus (product name: “PIXUS iP7230”, manufactured by Canon Inc.)
Piezo: a system of ejecting an ink from a recording head through the action of mechanical energy and an ink jet recording apparatus (product name: “LaboJet-500”, manufactured by MicroJet Corporation) Details of the base material shown in Tables 16 to 23 are shown below.
PET: product name: “PANACREA ACX”, manufactured by Panac Co., Ltd.
Glossy paper: product name: “Glossy Paper, Standard SD-201”, manufactured by Canon Inc.
Glass: product name: “cover glass NEO”, manufactured by Matsunami Glass Ind., Ltd.
Gelatin sheet: a product obtained by applying a 0.1% gelatin solution manufactured by FUJIFILM Wako Pure Chemical Corporation to the above-mentioned PET with a bar coater and drying the solution
Fibroin sheet: a product obtained by applying a 5% fibroin aqueous solution manufactured by Millipore Sigma to the above-mentioned PET with a bar coater and drying the solution

### Conductivity Evaluation

The thickness of the obtained conductive image was measured with a stylus thickness meter (manufactured by Tencor). The sectional area of the conductive image was calculated from the measured thickness and the volume resistivity thereof was measured and calculated by a four point probe method. The measured and calculated volume resistivities are shown in the right side of Tables 16 to 23. In addition, the conductivity of the conductive image was evaluated in accordance with the following evaluation criteria. In the following evaluation criteria, an acceptable range was defined as “A” and an unacceptable range was defined as “B”. The results are shown in the right side of Tables 16 to 23.

A: The volume resistivity was 1×10⁻⁴ Ω·cm or less.

B: The volume resistivity was more than 1×10⁻⁴ Ω·cm or no conductivity was shown.

TABLE 16
Production conditions of conductive composition (ink) and conductive image and evaluation results thereof

| Production conditions of conductive | | | | | | | | | | | | |
|---|---|---|---|---|---|---|---|---|---|---|---|---|
| composition (ink) | | | | | | | | | | | Evaluation results | |
| | | Conductive | Water- | Production conditions of conductive image | | | | | | | Volume | |
| | | composition | soluble | | | Conductive | | | Drying | Drying | resistivity | |
| | | (dispersion | organic | | | composition | | Base | temperature | time | (×10⁻⁵ | Conductivity |
| | | liquid) | solvent | | | (ink) | Ejection | material | (° C.) | (h) | (Ω · cm) | evaluation |
| Example | I1-1 | D1-1 | EG | Example | E1-1 | I1-1 | Thermal | PET | 25 | 24 | 5 | A |
| Example | I1-2 | D1-2 | EG | Example | E1-2 | I1-2 | Thermal | PET | 25 | 24 | 3 | A |
| Example | I1-3 | D1-3 | EG | Example | E1-3 | I1-3 | Thermal | PET | 25 | 24 | 3 | A |
| Example | I1-4 | D1-4 | EG | Example | E1-4 | I1-4 | Thermal | PET | 25 | 24 | 4 | A |
| Example | I1-5 | D1-5 | EG | Example | E1-5 | I1-5 | Thermal | PET | 25 | 24 | 3 | A |
| Example | I1-6 | D1-6 | EG | Example | E1-6 | I1-6 | Thermal | PET | 25 | 24 | 7 | A |
| Example | I1-7 | D1-7 | EG | Example | E1-7 | I1-7 | Thermal | PET | 25 | 24 | 6 | A |
| Example | I1-8 | D1-8 | EG | Example | E1-8 | I1-8 | Thermal | PET | 25 | 24 | 6 | A |
| Example | I1-9 | D1-9 | EG | Example | E1-9 | I1-9 | Thermal | PET | 25 | 24 | 7 | A |
| Example | I1-10 | D1-10 | EG | Example | E1-10 | I1-10 | Thermal | PET | 25 | 24 | 6 | A |
| Example | I1-11 | D1-11 | EG | Example | E1-11 | I1-11 | Thermal | PET | 25 | 24 | 6 | A |
| Example | I1-12 | D1-12 | EG | Example | E1-12 | I1-12 | Thermal | PET | 25 | 24 | 6 | A |
| Example | I1-13 | D1-13 | EG | Example | E1-13 | I1-13 | Thermal | PET | 25 | 24 | 7 | A |
| Example | I1-14 | D1-14 | EG | Example | E1-14 | I1-14 | Thermal | PET | 25 | 24 | 5 | A |
| Example | I1-15 | D1-15 | EG | Example | E1-15 | I1-15 | Thermal | PET | 25 | 24 | 7 | A |
| Example | I1-16 | D1-16 | EG | Example | E1-16 | I1-16 | Thermal | PET | 25 | 24 | 4 | A |
| Example | I1-17 | D1-17 | EG | Example | E1-17 | I1-17 | Thermal | PET | 25 | 24 | 3 | A |
| Example | I1-18 | D1-18 | EG | Example | E1-18 | I1-18 | Thermal | PET | 25 | 24 | 6 | A |
| Example | I1-19 | D1-19 | EG | Example | E1-19 | I1-19 | Thermal | PET | 25 | 24 | 5 | A |
| Example | I1-20 | D1-20 | EG | Example | E1-20 | I1-20 | Thermal | PET | 25 | 24 | 5 | A |
| Example | I1-21 | D1-21 | EG | Example | E1-21 | I1-21 | Thermal | PET | 25 | 24 | 5 | A |
| Example | I1-22 | D1-22 | EG | Example | E1-22 | I1-22 | Thermal | PET | 25 | 24 | 6 | A |
| Example | I1-23 | D1-23 | EG | Example | E1-23 | I1-23 | Thermal | PET | 25 | 24 | 5 | A |
| Example | I1-24 | D1-24 | EG | Example | E1-24 | I1-24 | Thermal | PET | 25 | 24 | 5 | A |
| Example | I1-25 | D1-25 | EG | Example | E1-25 | I1-25 | Thermal | PET | 25 | 24 | 4 | A |
| Example | I1-26 | D1-26 | EG | Example | E1-26 | I1-26 | Thermal | PET | 25 | 24 | 3 | A |
| Example | I1-27 | D1-27 | EG | Example | E1-27 | I1-27 | Thermal | PET | 25 | 24 | 6 | A |
| Example | I1-28 | D1-28 | EG | Example | E1-28 | I1-28 | Thermal | PET | 25 | 24 | 4 | A |
| Example | I1-29 | D1-29 | EG | Example | E1-29 | I1-29 | Thermal | PET | 25 | 24 | 3 | A |
| Example | I1-30 | D1-30 | EG | Example | E1-30 | I1-30 | Thermal | PET | 25 | 24 | 6 | A |
| Example | I1-31 | D1-31 | EG | Example | E1-31 | I1-31 | Thermal | PET | 25 | 24 | 8 | A |
| Example | I1-32 | D1-32 | EG | Example | E1-32 | I1-32 | Thermal | PET | 25 | 24 | 3 | A |
| Example | I1-33 | D1-33 | EG | Example | E1-33 | I1-33 | Thermal | PET | 25 | 24 | 6 | A |
| Example | I1-34 | D1-34 | EG | Example | E1-34 | I1-34 | Thermal | PET | 25 | 24 | 5 | A |
| Example | I1-35 | D1-35 | EG | Example | E1-35 | I1-35 | Thermal | PET | 25 | 24 | 6 | A |
| Example | I1-36 | D1-1 | BDO | Example | E1-36 | I1-36 | Thermal | PET | 25 | 24 | 5 | A |
| Example | I1-1 | D1-1 | EG | Example | E1-37 | I1-1 | Thermal | PET | 15 | 72 | 3 | A |
| Example | I1-1 | D1-1 | EG | Example | E1-38 | I1-1 | Thermal | PET | 20 | 24 | 2 | A |
| Example | I1-1 | D1-1 | EG | Example | E1-39 | I1-1 | Thermal | PET | 50 | 24 | 2 | A |
| Example | I1-1 | D1-1 | EG | Example | E1-40 | I1-1 | Thermal | PET | 80 | 10 | 2 | A |
| Example | I1-1 | D1-1 | EG | Example | E1-41 | I1-1 | Piezo | PET | 25 | 24 | 2 | A |
| Example | I1-1 | D1-1 | EG | Example | E1-42 | I1-1 | Thermal | Glossy | 25 | 24 | 3 | A |
| | | | | | | | | paper | | | | |
| Example | I1-1 | D1-1 | EG | Example | E1-43 | I1-1 | Thermal | Glass | 25 | 24 | 3 | A |
| Example | I1-1 | D1-1 | EG | Example | E1-44 | I1-1 | Thermal | Gelatin | 25 | 24 | 3 | A |
| | | | | | | | | sheet | | | | |
| Example | I1-1 | D1-1 | EG | Example | E1-45 | I1-1 | Thermal | Fibroin | 25 | 24 | 3 | A |
| | | | | | | | | sheet | | | | |

TABLE 17
Production conditions of conductive composition (ink) and conductive image and evaluation results thereof

| Production conditions of conductive | | | | | | | | | | | | |
|---|---|---|---|---|---|---|---|---|---|---|---|---|
| composition (ink) | | | | | | | | | | | Evaluation results | |
| | | Conductive | Water- | Production conditions of conductive image | | | | | | | Volume | |
| | | composition | soluble | | | Conductive | | | Drying | Drying | resistivity | |
| | | (dispersion | organic | | | composition | | Base | temperature | time | (×10⁻⁵ | Conductivity |
| | | liquid) | solvent | | | (ink) | Ejection | material | (° C.) | (h) | Ω · cm) | evaluation |
| Example | I2-1 | D2-1 | EG | Example | E2-1 | I2-1 | Thermal | PET | 25 | 24 | 3 | A |
| Example | I2-2 | D2-2 | EG | Example | E2-2 | I2-2 | Thermal | PET | 25 | 24 | 2 | A |
| Example | I2-3 | D2-3 | EG | Example | E2-3 | I2-3 | Thermal | PET | 25 | 24 | 3 | A |
| Example | I2-4 | D2-4 | EG | Example | E2-4 | I2-4 | Thermal | PET | 25 | 24 | 4 | A |
| Example | I2-5 | D2-5 | EG | Example | E2-5 | I2-5 | Thermal | PET | 25 | 24 | 3 | A |
| Example | I2-6 | D2-6 | EG | Example | E2-6 | I2-6 | Thermal | PET | 25 | 24 | 7 | A |
| Example | I2-7 | D2-7 | EG | Example | E2-7 | I2-7 | Thermal | PET | 25 | 24 | 7 | A |
| Example | I2-8 | D2-8 | EG | Example | E2-8 | I2-8 | Thermal | PET | 25 | 24 | 6 | A |
| Example | I2-9 | D2-9 | EG | Example | E2-9 | I2-9 | Thermal | PET | 25 | 24 | 6 | A |
| Example | I2-10 | D2-10 | EG | Example | E2-10 | I2-10 | Thermal | PET | 25 | 24 | 5 | A |
| Example | I2-11 | D2-11 | EG | Example | E2-11 | I2-11 | Thermal | PET | 25 | 24 | 4 | A |
| Example | I2-12 | D2-12 | EG | Example | E2-12 | I2-12 | Thermal | PET | 25 | 24 | 6 | A |
| Example | I2-13 | D2-13 | EG | Example | E2-13 | I2-13 | Thermal | PET | 25 | 24 | 6 | A |
| Example | I2-14 | D2-14 | EG | Example | E2-14 | I2-14 | Thermal | PET | 25 | 24 | 7 | A |
| Example | I2-15 | D2-15 | EG | Example | E2-15 | I2-15 | Thermal | PET | 25 | 24 | 7 | A |
| Example | I2-16 | D2-16 | EG | Example | E2-16 | I2-16 | Thermal | PET | 25 | 24 | 7 | A |
| Example | I2-17 | D2-17 | EG | Example | E2-17 | I2-17 | Thermal | PET | 25 | 24 | 6 | A |
| Example | I2-18 | D2-18 | EG | Example | E2-18 | I2-18 | Thermal | PET | 25 | 24 | 5 | A |
| Example | I2-19 | D2-19 | EG | Example | E2-19 | I2-19 | Thermal | PET | 25 | 24 | 5 | A |
| Example | I2-20 | D2-20 | EG | Example | E2-20 | I2-20 | Thermal | PET | 25 | 24 | 6 | A |
| Example | I2-21 | D2-21 | EG | Example | E2-21 | I2-21 | Thermal | PET | 25 | 24 | 6 | A |
| Example | I2-22 | D2-22 | EG | Example | E2-22 | I2-22 | Thermal | PET | 25 | 24 | 6 | A |
| Example | I2-23 | D2-23 | EG | Example | E2-23 | I2-23 | Thermal | PET | 25 | 24 | 6 | A |
| Example | I2-24 | D2-24 | EG | Example | E2-24 | I2-24 | Thermal | PET | 25 | 24 | 4 | A |
| Example | I2-25 | D2-25 | EG | Example | E2-25 | I2-25 | Thermal | PET | 25 | 24 | 4 | A |
| Example | I2-26 | D2-26 | EG | Example | E2-26 | I2-26 | Thermal | PET | 25 | 24 | 6 | A |
| Example | I2-27 | D2-27 | EG | Example | E2-27 | I2-27 | Thermal | PET | 25 | 24 | 3 | A |
| Example | I2-28 | D2-28 | EG | Example | E2-28 | I2-28 | Thermal | PET | 25 | 24 | 5 | A |
| Example | I2-29 | D2-29 | EG | Example | E2-29 | I2-29 | Thermal | PET | 25 | 24 | 3 | A |
| Example | I2-30 | D2-30 | EG | Example | E2-30 | I2-30 | Thermal | PET | 25 | 24 | 5 | A |
| Example | I2-31 | D2-31 | EG | Example | E2-31 | I2-31 | Thermal | PET | 25 | 24 | 3 | A |
| Example | I2-32 | D2-32 | EG | Example | E2-32 | I2-32 | Thermal | PET | 25 | 24 | 5 | A |
| Example | I2-33 | D2-33 | EG | Example | E2-33 | I2-33 | Thermal | PET | 25 | 24 | 4 | A |
| Example | I2-34 | D2-34 | EG | Example | E2-34 | I2-34 | Thermal | PET | 25 | 24 | 3 | A |
| Example | I2-35 | D2-35 | EG | Example | E2-35 | I2-35 | Thermal | PET | 25 | 24 | 4 | A |
| Example | I2-36 | D2-36 | EG | Example | E2-36 | I2-36 | Thermal | PET | 25 | 24 | 3 | A |
| Example | I2-37 | D2-37 | EG | Example | E2-37 | I2-37 | Thermal | PET | 25 | 24 | 3 | A |
| Example | I2-38 | D2-38 | EG | Example | E2-38 | I2-38 | Thermal | PET | 25 | 24 | 20 | A |
| Example | I2-39 | D2-39 | EG | Example | E2-39 | I2-39 | Thermal | PET | 25 | 24 | 3 | A |
| Example | I2-40 | D2-40 | EG | Example | E2-40 | I2-40 | Thermal | PET | 25 | 24 | 5 | A |
| Example | I2-41 | D2-41 | EG | Example | E2-41 | I2-41 | Thermal | PET | 25 | 24 | 5 | A |
| Example | I2-42 | D2-42 | EG | Example | E2-42 | I2-42 | Thermal | PET | 25 | 24 | 4 | A |
| Example | I2-43 | D2-1 | BDO | Example | E2-43 | I2-43 | Thermal | PET | 25 | 24 | 3 | A |
| Example | I2-1 | D2-1 | EG | Example | E2-44 | I2-1 | Thermal | PET | 15 | 72 | 2 | A |
| Example | I2-1 | D2-1 | EG | Example | E2-45 | I2-1 | Thermal | PET | 20 | 24 | 2 | A |
| Example | I2-1 | D2-1 | EG | Example | E2-46 | I2-1 | Thermal | PET | 50 | 24 | 2 | A |
| Example | I2-1 | D2-1 | EG | Example | E2-47 | I2-1 | Thermal | PET | 80 | 10 | 2 | A |
| Example | I2-1 | D2-1 | EG | Example | E2-48 | I2-1 | Piezo | PET | 25 | 24 | 2 | A |
| Example | I2-1 | D2-1 | EG | Example | E2-49 | I2-1 | Thermal | Glossy | 25 | 24 | 2 | A |
| | | | | | | | | paper | | | | |
| Example | I2-1 | D2-1 | EG | Example | E2-50 | I2-1 | Thermal | Glass | 25 | 24 | 2 | A |
| Example | I2-1 | D2-1 | EG | Example | E2-51 | I2-1 | Thermal | Gelatin | 25 | 24 | 2 | A |
| | | | | | | | | sheet | | | | |
| Example | I2-1 | D2-1 | EG | Example | E2-52 | I2-1 | Thermal | Fibroin | 25 | 24 | 2 | A |
| | | | | | | | | sheet | | | | |

TABLE 18
Production conditions of conductive composition (ink) and conductive image and characteristics thereof

| Production conditions of conductive | | | | | | | | | | | | |
|---|---|---|---|---|---|---|---|---|---|---|---|---|
| composition (ink) | | | | | | | | | | | Evaluation results | |
| | | Conductive | Water- | Production conditions of conductive image | | | | | | | Volume | |
| | | composition | soluble | | | Conductive | | | Drying | Drying | resistivity | |
| | | (dispersion | organic | | | composition | | Base | temperature | time | (×10⁻⁵ | Conductivity |
| | | liquid) | solvent | | | (ink) | Ejection | material | (° C.) | (h) | Ω · cm) | evaluation |
| Example | I3-1 | D3-1 | EG | Example | E3-1 | I3-1 | Thermal | PET | 25 | 24 | 2 | A |
| Example | I3-2 | D3-2 | EG | Example | E3-2 | I3-2 | Thermal | PET | 25 | 24 | 3 | A |
| Example | I3-3 | D3-3 | EG | Example | E3-3 | I3-3 | Thermal | PET | 25 | 24 | 6 | A |
| Example | I3-4 | D3-4 | EG | Example | E3-4 | I3-4 | Thermal | PET | 25 | 24 | 4 | A |
| Example | I3-5 | D3-5 | EG | Example | E3-5 | I3-5 | Thermal | PET | 25 | 24 | 3 | A |
| Example | I3-6 | D3-6 | EG | Example | E3-6 | I3-6 | Thermal | PET | 25 | 24 | 7 | A |
| Example | I3-7 | D3-7 | EG | Example | E3-7 | I3-7 | Thermal | PET | 25 | 24 | 1 | A |
| Example | I3-8 | D3-8 | EG | Example | E3-8 | I3-8 | Thermal | PET | 25 | 24 | 1 | A |
| Example | I3-9 | D3-9 | EG | Example | E3-9 | I3-9 | Thermal | PET | 25 | 24 | 6 | A |
| Example | I3-10 | D3-10 | EG | Example | E3-10 | I3-10 | Thermal | PET | 25 | 24 | 7 | A |
| Example | I3-11 | D3-11 | EG | Example | E3-11 | I3-11 | Thermal | PET | 25 | 24 | 8 | A |
| Example | I3-12 | D3-12 | EG | Example | E3-12 | I3-12 | Thermal | PET | 25 | 24 | 7 | A |
| Example | I3-13 | D3-13 | EG | Example | E3-13 | I3-13 | Thermal | PET | 25 | 24 | 7 | A |
| Example | I3-14 | D3-14 | EG | Example | E3-14 | I3-14 | Thermal | PET | 25 | 24 | 8 | A |
| Example | I3-15 | D3-15 | EG | Example | E3-15 | I3-15 | Thermal | PET | 25 | 24 | 8 | A |
| Example | I3-16 | D3-16 | EG | Example | E3-16 | I3-16 | Thermal | PET | 25 | 24 | 7 | A |
| Example | I3-17 | D3-17 | EG | Example | E3-17 | I3-17 | Thermal | PET | 25 | 24 | 1 | A |
| Example | I3-18 | D3-18 | EG | Example | E3-18 | I3-18 | Thermal | PET | 25 | 24 | 2 | A |
| Example | I3-19 | D3-19 | EG | Example | E3-19 | I3-19 | Thermal | PET | 25 | 24 | 2 | A |
| Example | I3-20 | D3-20 | EG | Example | E3-20 | I3-20 | Thermal | PET | 25 | 24 | 3 | A |
| Example | I3-21 | D3-21 | EG | Example | E3-21 | I3-21 | Thermal | PET | 25 | 24 | 5 | A |
| Example | I3-22 | D3-22 | EG | Example | E3-22 | I3-22 | Thermal | PET | 25 | 24 | 3 | A |
| Example | I3-23 | D3-1 | BDO | Example | E3-23 | I3-23 | Thermal | PET | 25 | 24 | 4 | A |
| Example | I3-1 | D3-1 | EG | Example | E3-24 | I3-1 | Thermal | PET | 15 | 72 | 3 | A |
| Example | I3-1 | D3-1 | EG | Example | E3-25 | I3-1 | Thermal | PET | 20 | 24 | 3 | A |
| Example | I3-1 | D3-1 | EG | Example | E3-26 | I3-1 | Thermal | PET | 50 | 24 | 2 | A |
| Example | I3-1 | D3-1 | EG | Example | E3-27 | I3-1 | Thermal | PET | 80 | 10 | 1 | A |
| Example | I3-1 | D3-1 | EG | Example | E3-28 | I3-1 | Piezo | PET | 25 | 24 | 2 | A |
| Example | I3-1 | D3-1 | EG | Example | E3-29 | I3-1 | Thermal | Glossy | 25 | 24 | 1 | A |
| | | | | | | | | paper | | | | |
| Example | I3-1 | D3-1 | EG | Example | E3-30 | I3-1 | Thermal | Glass | 25 | 24 | 3 | A |
| Example | I3-1 | D3-1 | EG | Example | E3-31 | I3-1 | Thermal | Gelatin | 25 | 24 | 2 | A |
| | | | | | | | | sheet | | | | |
| Example | I3-1 | D3-1 | EG | Example | E3-32 | I3-1 | Thermal | Fibroin | 25 | 24 | 2 | A |
| | | | | | | | | sheet | | | | |

TABLE 19
Production conditions of conductive composition (ink) and conductive image and characteristics thereof

| Production conditions of conductive | | | | | | | | | | | | |
|---|---|---|---|---|---|---|---|---|---|---|---|---|
| composition (ink) | | | | | | | | | | | Evaluation results | |
| | | Conductive | Water- | Production conditions of conductive image | | | | | | | Volume | |
| | | composition | soluble | | | Conductive | | | Drying | Drying | resistivity | |
| | | (dispersion | organic | | | composition | | Base | temperature | time | (×10⁻⁵ | Conductivity |
| | | liquid) | solvent | | | (ink) | Ejection | material | (° C.) | (h) | (Ω · cm) | evaluation |
| Example | I4-1 | D4-1 | EG | Example | E4-1 | I4-1 | Thermal | PET | 25 | 24 | 2 | A |
| Example | I4-2 | D4-2 | EG | Example | E4-2 | I4-2 | Thermal | PET | 25 | 24 | 3 | A |
| Example | I4-3 | D4-3 | EG | Example | E4-3 | I4-3 | Thermal | PET | 25 | 24 | 6 | A |
| Example | I4-4 | D4-4 | EG | Example | E4-4 | I4-4 | Thermal | PET | 25 | 24 | 4 | A |
| Example | I4-5 | D4-5 | EG | Example | E4-5 | I4-5 | Thermal | PET | 25 | 24 | 3 | A |
| Example | I4-6 | D4-6 | EG | Example | E4-6 | I4-6 | Thermal | PET | 25 | 24 | 7 | A |
| Example | I4-7 | D4-7 | EG | Example | E4-7 | I4-7 | Thermal | PET | 25 | 24 | 3 | A |
| Example | I4-8 | D4-8 | EG | Example | E4-8 | I4-8 | Thermal | PET | 25 | 24 | 7 | A |
| Example | I4-9 | D4-9 | EG | Example | E4-9 | I4-9 | Thermal | PET | 25 | 24 | 6 | A |
| Example | I4-10 | D4-10 | EG | Example | E4-10 | I4-10 | Thermal | PET | 25 | 24 | 7 | A |
| Example | I4-11 | D4-11 | EG | Example | E4-11 | I4-11 | Thermal | PET | 25 | 24 | 8 | A |
| Example | I4-12 | D4-12 | EG | Example | E4-12 | I4-12 | Thermal | PET | 25 | 24 | 7 | A |
| Example | I4-13 | D4-13 | EG | Example | E4-13 | I4-13 | Thermal | PET | 25 | 24 | 8 | A |
| Example | I4-14 | D4-14 | EG | Example | E4-14 | I4-14 | Thermal | PET | 25 | 24 | 7 | A |
| Example | I4-15 | D4-15 | EG | Example | E4-15 | I4-15 | Thermal | PET | 25 | 24 | 9 | A |
| Example | I4-16 | D4-16 | EG | Example | E4-16 | I4-16 | Thermal | PET | 25 | 24 | 8 | A |
| Example | I4-17 | D4-17 | EG | Example | E4-17 | I4-17 | Thermal | PET | 25 | 24 | 8 | A |
| Example | I4-18 | D4-18 | EG | Example | E4-18 | I4-18 | Thermal | PET | 25 | 24 | 9 | A |
| Example | I4-19 | D4-19 | EG | Example | E4-19 | I4-19 | Thermal | PET | 25 | 24 | 5 | A |
| Example | I4-20 | D4-20 | EG | Example | E4-20 | I4-20 | Thermal | PET | 25 | 24 | 6 | A |
| Example | I4-21 | D4-21 | EG | Example | E4-21 | I4-21 | Thermal | PET | 25 | 24 | 8 | A |
| Example | I4-22 | D4-22 | EG | Example | E4-22 | I4-22 | Thermal | PET | 25 | 24 | 9 | A |
| Example | I4-23 | D4-23 | EG | Example | E4-23 | I4-23 | Thermal | PET | 25 | 24 | 7 | A |
| Example | I4-24 | D4-11 | BDO | Example | E4-24 | I4-24 | Thermal | PET | 25 | 24 | 7 | A |
| Example | I4-11 | D4-11 | EG | Example | E4-25 | I4-11 | Thermal | PET | 15 | 72 | 9 | A |
| Example | I4-11 | D4-11 | EG | Example | E4-26 | I4-11 | Thermal | PET | 20 | 24 | 8 | A |
| Example | I4-11 | D4-11 | EG | Example | E4-27 | I4-11 | Thermal | PET | 50 | 24 | 6 | A |
| Example | I4-11 | D4-11 | EG | Example | E4-28 | I4-11 | Thermal | PET | 80 | 10 | 5 | A |
| Example | I4-11 | D4-11 | EG | Example | E4-29 | I4-11 | Piezo | PET | 25 | 24 | 5 | A |
| Example | I4-11 | D4-11 | EG | Example | E4-30 | I4-11 | Thermal | Glossy | 25 | 24 | 1 | A |
| | | | | | | | | paper | | | | |
| Example | I4-11 | D4-11 | EG | Example | E4-31 | I4-11 | Thermal | Glass | 25 | 24 | 8 | A |
| Example | I4-11 | D4-11 | EG | Example | E4-32 | I4-11 | Thermal | Gelatin | 25 | 24 | 8 | A |
| | | | | | | | | sheet | | | | |
| Example | I4-11 | D4-11 | EG | Example | E4-33 | I4-11 | Thermal | Fibroin | 25 | 24 | 7 | A |
| | | | | | | | | sheet | | | | |

TABLE 20
Production conditions of conductive composition (ink) and conductive image and evaluation results thereof

| Production conditions of conductive | | | | | | | | | | | | |
|---|---|---|---|---|---|---|---|---|---|---|---|---|
| composition (ink) | | | | | | | | | | | Evaluation results | |
| | | Conductive | Water- | Production conditions of conductive image | | | | | | | Volume | |
| | | composition | soluble | | | Conductive | | | Drying | Drying | resistivity | |
| | | (dispersion | organic | | | composition | | Base | temperature | time | (×10⁻⁵ | Conductivity |
| | | liquid) | solvent | | | (ink) | Ejection | material | (° C.) | (h) | Ω · cm | evaluation |
| Example | I5-1 | D5-1 | EG | Example | E5-1 | I5-1 | Thermal | PET | 25 | 24 | 6 | A |
| Example | I5-2 | D5-2 | EG | Example | E5-2 | I5-2 | Thermal | PET | 25 | 24 | 3 | A |
| Example | I5-3 | D5-3 | EG | Example | E5-3 | I5-3 | Thermal | PET | 25 | 24 | 3 | A |
| Example | I5-4 | D5-4 | EG | Example | E5-4 | I5-4 | Thermal | PET | 25 | 24 | 4 | A |
| Example | I5-5 | D5-5 | EG | Example | E5-5 | I5-5 | Thermal | PET | 25 | 24 | 3 | A |
| Example | I5-6 | D5-6 | EG | Example | E5-6 | I5-6 | Thermal | PET | 25 | 24 | 8 | A |
| Example | I5-7 | D5-7 | EG | Example | E5-7 | I5-7 | Thermal | PET | 25 | 24 | 5 | A |
| Example | I5-8 | D5-8 | EG | Example | E5-8 | I5-8 | Thermal | PET | 25 | 24 | 5 | A |
| Example | I5-9 | D5-9 | EG | Example | E5-9 | I5-9 | Thermal | PET | 25 | 24 | 7 | A |
| Example | I5-10 | D5-10 | EG | Example | E5-10 | I5-10 | Thermal | PET | 25 | 24 | 6 | A |
| Example | I5-11 | D5-11 | EG | Example | E5-11 | I5-11 | Thermal | PET | 25 | 24 | 5 | A |
| Example | I5-12 | D5-12 | EG | Example | E5-12 | I5-12 | Thermal | PET | 25 | 24 | 5 | A |
| Example | I5-13 | D5-13 | EG | Example | E5-13 | I5-13 | Thermal | PET | 25 | 24 | 3 | A |
| Example | I5-14 | D5-14 | EG | Example | E5-14 | I5-14 | Thermal | PET | 25 | 24 | 3 | A |
| Example | I5-15 | D5-15 | EG | Example | E5-15 | I5-15 | Thermal | PET | 25 | 24 | 7 | A |
| Example | I5-16 | D5-16 | EG | Example | E5-16 | I5-16 | Thermal | PET | 25 | 24 | 4 | A |
| Example | I5-17 | D5-17 | EG | Example | E5-17 | I5-17 | Thermal | PET | 25 | 24 | 5 | A |
| Example | I5-18 | D5-18 | EG | Example | E5-18 | I5-18 | Thermal | PET | 25 | 24 | 6 | A |
| Example | I5-19 | D5-19 | EG | Example | E5-19 | I5-19 | Thermal | PET | 25 | 24 | 8 | A |
| Example | I5-20 | D5-20 | EG | Example | E5-20 | I5-20 | Thermal | PET | 25 | 24 | 8 | A |
| Example | I5-21 | D5-21 | EG | Example | E5-21 | I5-21 | Thermal | PET | 25 | 24 | 3 | A |
| Example | I5-22 | D5-22 | EG | Example | E5-22 | I5-22 | Thermal | PET | 25 | 24 | 20 | A |
| Example | I5-23 | D5-23 | EG | Example | E5-23 | I5-23 | Thermal | PET | 25 | 24 | 5 | A |
| Example | I5-24 | D5-24 | EG | Example | E5-24 | I5-24 | Thermal | PET | 25 | 24 | 3 | A |
| Example | I5-25 | D5-25 | EG | Example | E5-25 | I5-25 | Thermal | PET | 25 | 24 | 30 | A |
| Example | I5-26 | D5-26 | EG | Example | E5-26 | I5-26 | Thermal | PET | 25 | 24 | 3 | A |
| Example | I5-27 | D5-13 | BDO | Example | E5-27 | I5-27 | Thermal | PET | 25 | 24 | 4 | A |
| Example | I5-13 | D5-13 | EG | Example | E5-28 | I5-13 | Thermal | PET | 15 | 72 | 3 | A |
| Example | I5-13 | D5-13 | EG | Example | E5-29 | I5-13 | Thermal | PET | 20 | 24 | 3 | A |
| Example | I5-13 | D5-13 | EG | Example | E5-30 | I5-13 | Thermal | PET | 50 | 24 | 2 | A |
| Example | I5-13 | D5-13 | EG | Example | E5-31 | I5-13 | Thermal | PET | 80 | 10 | 3 | A |
| Example | I5-13 | D5-13 | EG | Example | E5-32 | I5-13 | Piezo | PET | 25 | 24 | 2 | A |
| Example | I5-13 | D5-13 | EG | Example | E5-33 | I5-13 | Thermal | Glossy | 25 | 24 | 4 | A |
| | | | | | | | | Paper | | | | |
| Example | I5-13 | D5-13 | EG | Example | E5-34 | I5-13 | Thermal | Glass | 25 | 24 | 3 | A |
| Example | I5-13 | D5-13 | EG | Example | E5-35 | I5-13 | Thermal | Gelatin | 25 | 24 | 3 | A |
| | | | | | | | | sheet | | | | |
| Example | I5-13 | D5-13 | EG | Example | E5-36 | I5-13 | Thermal | Fibroin | 25 | 24 | 3 | A |
| | | | | | | | | sheet | | | | |

TABLE 21
Production conditions of conductive composition (ink) and conductive image and evaluation results thereof

| Production conditions of conductive | | | | | | | | | | | | |
|---|---|---|---|---|---|---|---|---|---|---|---|---|
| composition (ink) | | | | | | | | | | | Evaluation results | |
| | | Conductive | Water- | Production conditions of conductive image | | | | | | | Volume | |
| | | composition | soluble | | | Conductive | | | Drying | Drying | resistivity | |
| | | (dispersion | organic | | | composition | | Base | temperature | time | (×10⁻⁵ | Conductivity |
| | | liquid) | solvent | | | (ink) | Ejection | material | (° C.) | (h) | Ω · cm) | evaluation |
| Example | I6-1 | D6-1 | EG | Example | E6-1 | I6-1 | Thermal | PET | 25 | 24 | 2 | A |
| Example | I6-2 | D6-2 | EG | Example | E6-2 | I6-2 | Thermal | PET | 25 | 24 | 3 | A |
| Example | I6-3 | D6-3 | EG | Example | E6-3 | I6-3 | Thermal | PET | 25 | 24 | 5 | A |
| Example | I6-4 | D6-4 | EG | Example | E6-4 | I6-4 | Thermal | PET | 25 | 24 | 4 | A |
| Example | I6-5 | D6-5 | EG | Example | E6-5 | I6-5 | Thermal | PET | 25 | 24 | 6 | A |
| Example | I6-6 | D6-6 | EG | Example | E6-6 | I6-6 | Thermal | PET | 25 | 24 | 3 | A |
| Example | I6-7 | D6-7 | EG | Example | E6-7 | I6-7 | Thermal | PET | 25 | 24 | 9 | A |
| Example | I6-8 | D6-8 | EG | Example | E6-8 | I6-8 | Thermal | PET | 25 | 24 | 2 | A |
| Example | I6-9 | D6-9 | EG | Example | E6-9 | I6-9 | Thermal | PET | 25 | 24 | 2 | A |
| Example | I6-10 | D6-10 | EG | Example | E6-10 | I6-10 | Thermal | PET | 25 | 24 | 3 | A |
| Example | I6-11 | D6-11 | EG | Example | E6-11 | I6-11 | Thermal | PET | 25 | 24 | 4 | A |
| Example | I6-12 | D6-12 | EG | Example | E6-12 | I6-12 | Thermal | PET | 25 | 24 | 6 | A |
| Example | I6-13 | D6-13 | EG | Example | E6-13 | I6-13 | Thermal | PET | 25 | 24 | 6 | A |
| Example | I6-14 | D6-14 | EG | Example | E6-14 | I6-14 | Thermal | PET | 25 | 24 | 7 | A |
| Example | I6-15 | D6-15 | EG | Example | E6-15 | I6-15 | Thermal | PET | 25 | 24 | 9 | A |
| Example | I6-16 | D6-16 | EG | Example | E6-16 | I6-16 | Thermal | PET | 25 | 24 | 8 | A |
| Example | I6-17 | D6-17 | EG | Example | E6-17 | I6-17 | Thermal | PET | 25 | 24 | 9 | A |
| Example | I6-18 | D6-18 | EG | Example | E6-18 | I6-18 | Thermal | PET | 25 | 24 | 7 | A |
| Example | I6-19 | D6-19 | EG | Example | E6-19 | I6-19 | Thermal | PET | 25 | 24 | 5 | A |
| Example | I6-20 | D6-20 | EG | Example | E6-20 | I6-20 | Thermal | PET | 25 | 24 | 2 | A |
| Example | I6-21 | D6-21 | EG | Example | E6-21 | I6-21 | Thermal | PET | 25 | 24 | 2 | A |
| Example | I6-22 | D6-22 | EG | Example | E6-22 | I6-22 | Thermal | PET | 25 | 24 | 3 | A |
| Example | I6-23 | D6-23 | EG | Example | E6-23 | I6-23 | Thermal | PET | 25 | 24 | 0.8 | A |
| Example | I6-24 | D6-24 | EG | Example | E6-24 | I6-24 | Thermal | PET | 25 | 24 | 2 | A |
| Example | I6-25 | D6-25 | EG | Example | E6-25 | I6-25 | Thermal | PET | 25 | 24 | 3 | A |
| Example | I6-26 | D6-26 | EG | Example | E6-26 | I6-26 | Thermal | PET | 25 | 24 | 5 | A |
| Example | I6-27 | D6-27 | EG | Example | E6-27 | I6-27 | Thermal | PET | 25 | 24 | 6 | A |
| Example | I6-28 | D6-28 | EG | Example | E6-28 | I6-28 | Thermal | PET | 25 | 24 | 3 | A |
| Example | I6-29 | D6-1 | BDO | Example | E6-29 | I6-29 | Thermal | PET | 25 | 24 | 2 | A |
| Example | I6-1 | D6-1 | EG | Example | E6-30 | I6-1 | Thermal | PET | 15 | 72 | 3 | A |
| Example | I6-1 | D6-1 | EG | Example | E6-31 | I6-1 | Thermal | PET | 20 | 24 | 3 | A |
| Example | I6-1 | D6-1 | EG | Example | E6-32 | I6-1 | Thermal | PET | 50 | 24 | 2 | A |
| Example | I6-1 | D6-1 | EG | Example | E6-33 | I6-1 | Thermal | PET | 80 | 10 | 2 | A |
| Example | I6-1 | D6-1 | EG | Example | E6-34 | I6-1 | Piezo | PET | 25 | 24 | 4 | A |
| Example | I6-1 | D6-1 | EG | Example | E6-35 | I6-1 | Thermal | Glossy | 25 | 24 | 8 | A |
| | | | | | | | | paper | | | | |
| Example | I6-1 | D6-1 | EG | Example | E6-36 | I6-1 | Thermal | Glass | 25 | 24 | 3 | A |
| Example | I6-1 | D6-1 | EG | Example | E6-37 | I6-1 | Thermal | Gelatin | 25 | 24 | 7 | A |
| | | | | | | | | sheet | | | | |
| Example | I6-1 | D6-1 | EG | Example | E6-38 | I6-1 | Thermal | Fibroin | 25 | 24 | 3 | A |
| | | | | | | | | sheet | | | | |

TABLE 22
Production conditions of conductive composition (ink) and conductive image and evaluation results thereof

| Production conditions of conductive | | | | | | | | | | | | |
|---|---|---|---|---|---|---|---|---|---|---|---|---|
| composition (ink) | | | | | | | | | | | Evaluation results | |
| | | Conductive | Water- | Production conditions of conductive image | | | | | | | Volume | |
| | | composition | soluble | | | Conductive | | | Drying | Drying | resistivity | |
| | | (dispersion | organic | | | composition | | Base | temperature | time | (×10⁻⁵ | Conductivity |
| | | liquid) | solvent | | | (ink) | Ejection | material | (° C.) | (h) | Ω · cm) | evaluation |
| Example | I7-1 | D7-1 | EG | Example | E7-1 | I7-1 | Thermal | PET | 25 | 24 | 3 | A |
| Example | I7-2 | D7-2 | EG | Example | E7-2 | I7-2 | Thermal | PET | 25 | 24 | 8 | A |
| Example | I7-3 | D7-3 | EG | Example | E7-3 | I7-3 | Thermal | PET | 25 | 24 | 7 | A |
| Example | I7-4 | D7-4 | EG | Example | E7-4 | I7-4 | Thermal | PET | 25 | 24 | 9 | A |
| Example | I7-5 | D7-5 | EG | Example | E7-5 | I7-5 | Thermal | PET | 25 | 24 | 2 | A |
| Example | I7-6 | D7-6 | EG | Example | E7-6 | I7-6 | Thermal | PET | 25 | 24 | 2 | A |
| Example | I7-7 | D7-7 | EG | Example | E7-7 | I7-7 | Thermal | PET | 25 | 24 | 0.9 | A |
| Example | I7-8 | D7-8 | EG | Example | E7-8 | I7-8 | Thermal | PET | 25 | 24 | 1 | A |
| Example | I7-9 | D7-9 | EG | Example | E7-9 | I7-9 | Thermal | PET | 25 | 24 | 2 | A |
| Example | I7-10 | D7-10 | EG | Example | E7-10 | I7-10 | Thermal | PET | 25 | 24 | 6 | A |
| Example | I7-11 | D7-11 | EG | Example | E7-11 | I7-11 | Thermal | PET | 25 | 24 | 7 | A |
| Example | I7-12 | D7-12 | EG | Example | E7-12 | I7-12 | Thermal | PET | 25 | 24 | 3 | A |
| Example | I7-13 | D7-5 | BDO | Example | E7-13 | I7-13 | Thermal | PET | 25 | 24 | 1 | A |
| Example | I7-5 | D7-5 | EG | Example | E7-14 | I7-5 | Thermal | PET | 15 | 72 | 2 | A |
| Example | I7-5 | D7-5 | EG | Example | E7-15 | I7-5 | Thermal | PET | 20 | 24 | 4 | A |
| Example | I7-5 | D7-5 | EG | Example | E7-16 | I7-5 | Thermal | PET | 50 | 24 | 3 | A |
| Example | I7-5 | D7-5 | EG | Example | E7-17 | I7-5 | Thermal | PET | 80 | 10 | 2 | A |
| Example | I7-5 | D7-5 | EG | Example | E7-18 | I7-5 | Piezo | PET | 25 | 24 | 2 | A |
| Example | I7-5 | D7-5 | EG | Example | E7-19 | I7-5 | Thermal | Glossy | 25 | 24 | 9 | A |
| | | | | | | | | paper | | | | |
| Example | I7-5 | D7-5 | EG | Example | E7-20 | I7-5 | Thermal | Glass | 25 | 24 | 3 | A |
| Example | I7-5 | D7-5 | EG | Example | E7-21 | I7-5 | Thermal | Gelatin | 25 | 24 | 8 | A |
| | | | | | | | | sheet | | | | |
| Example | I7-5 | D7-5 | EG | Example | E7-22 | I7-5 | Thermal | Fibroin | 25 | 24 | 2 | A |
| | | | | | | | | sheet | | | | |

TABLE 23
Production conditions of conductive composition (ink) and conductive image and evaluation results thereof

| Production conditions of conductive | | | | | | | | | | | | |
|---|---|---|---|---|---|---|---|---|---|---|---|---|
| composition (ink) | | | | | | | | | | | Evaluation results | |
| | | Conductive | Water- | Production conditions of conductive image | | | | | | | Volume | |
| | | composition | soluble | | | Conductive | | | Drying | Drying | resistivity | |
| | | (dispersion | organic | | | composition | | Base | temperature | time | (×10⁻⁵ | Conductivity |
| | | liquid) | solvent | | | (ink) | Ejection | material | (° C.) | (h) | Ω · cm) | evaluation |
| Comparative | I1 | D1 | EG | Comparative | E1 | I1 | Thermal | PET | 25 | 24 | 60 | B |
| Example | | | | Example | | | | | | | | |
| Comparative | I2 | D2 | EG | Comparative | E2 | I2 | Thermal | PET | 25 | 24 | — | B |
| Example | | | | Example | | | | | | | | |
| Comparative | I3 | D3 | DEGmEE | Comparative | E3 | I3 | Piezo | Polyimide | 230 | 0.1 | 5 | A |
| Example | | | | Example | | | | film | | | | |
| Comparative | I3 | D3 | DEGmEE | Comparative | E4 | I3 | Piezo | Polyimide | 25 | 24 | 54 | B |
| Example | | | | Example | | | | film | | | | |

According to the present invention, the conductive composition with which a conductive image excellent in conductivity can be easily recorded by only performing simple posttreatment can be provided. In addition, according to the present invention, the method of producing the conductive composition, the method of recording a conductive image using the conductive composition and the conductive image can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A conductive composition comprising:
a metal particle; and
a treatment agent for coating the metal particle,
wherein the treatment agent is at least one kind selected from the group consisting of: a compound represented by the following general formula (1); a compound represented by the following general formula (2); a compound represented by the following general formula (3); a compound represented by the following general formula (4); a compound represented by the following general formula (5); a compound represented by the following general formula (6); and a compound represented by the following general formula (7): 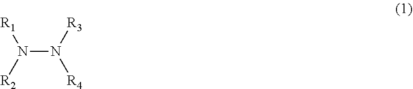
in the general formula (1), R₁ to R₄ each independently represent a hydrogen atom, an aliphatic group, an aromatic group, an acid ester group or a hydrophilic group, at least one of R₁ to R₄ represents the hydrophilic group, not all of the rest of R₁ to R₄ simultaneously represent hydrogen atoms and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond; 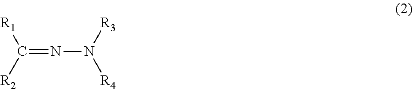
in the general formula (2), R₁ to R₄ each independently represent a hydrogen atom, an aliphatic group, an aromatic group, an acid ester group or a hydrophilic group, at least one of R₁ to R₄ represents the hydrophilic group, not all of the rest of R₁ to R₄ simultaneously represent hydrogen atoms and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond;
R₁—N═N—R₂ (3)
in the general formula (3), R₁ to R₂ each independently represent an aromatic group or a hydrophilic group, at least one of R₁ to R₂ represents the hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond;
R₁—N═N—NH—R₂ (4)
in the general formula (4), R₁ to R₂ each independently represent an aromatic group or a hydrophilic group, at least one of R₁ to R₂ represents the hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond;
R₁—CN (5)
in the general formula (5), R₁ represents a hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond; 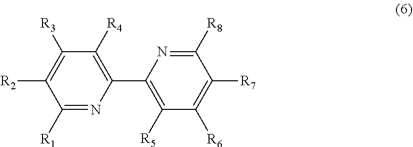
in the general formula (6), R₁ to R₈ each independently represent a hydrogen atom, an aliphatic group, an aromatic group, an acid ester group or a hydrophilic group, at least one of R₁ to R₈ represents the hydrophilic group and the hydrophilic group is: (i) any hydrophilic functional group selected from the group consisting of: a hydroxy group; a carboxylic acid group; a sulfonic acid group; a phosphoric acid group; a phosphonic acid group; a tertiary alkylamino group; and a heteroaromatic group; or (ii) an aliphatic group to which the hydrophilic functional group is bonded and which may have a heteroatom, an amide bond or an ester bond; and 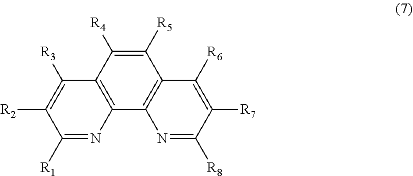
in the general formula (7), R₁ to R₈ each independently represent a hydrogen atom, an aliphatic group, an aromatic group, an acid ester group or a hydrophilic group, at least one of R₁ to R₈ represents the hydrophilic group and the hydrophilic group is: (i) any hydrophilic functional group selected from the group consisting of: a hydroxy group;
a carboxylic acid group; a sulfonic acid group; a phosphoric acid group; a phosphonic acid group; a tertiary alkylamino group; and a heteroaromatic group; or (ii) an aliphatic group to which the hydrophilic functional group is bonded and which may have a heteroatom, an amide bond or an ester bond.

2. The conductive composition according to claim 1, wherein the hydrophilic group in the general formula (1), the hydrophilic group in the general formula (2), the hydrophilic group in the general formula (3), the hydrophilic group in the general formula (4) and the hydrophilic group in the general formula (5) are each independently: (ii) a phenyl group to which the hydrophilic functional group is bonded; or (iii) a phenyl group to which the hydrophilic functional group is bonded via an aliphatic group that may have a heteroatom, an amide bond or an ester bond.

3. The conductive composition according to claim 2, wherein the hydrophilic groups are each a phenyl group to which at least one of a carboxylic acid group and a sulfonic acid group is bonded.

4. The conductive composition according to claim 3, wherein a total number of the carboxylic acid groups and the sulfonic acid groups bonded to the phenyl group is 2 or 3.

5. The conductive composition according to claim 1, wherein the hydrophilic group in the general formula (1) and the hydrophilic group in the general formula (2) are each independently (i) any heteroaromatic group selected from the group consisting of: a pyridazyl group; a pyrazyl group; a pyrimidyl group; and a triazyl group.

6. The conductive composition according to claim 1, wherein the hydrophilic group in the general formula (6) and the hydrophilic group in the general formula (7) are each independently a group represented by the following general formula (8): 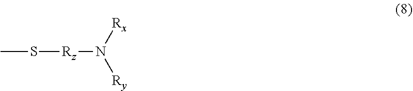
in the general formula (8), Rx and R_{y} each independently represent an alkyl group and Rz represents an alkylene group.

7. The conductive composition according to claim 1, wherein the metal particle is formed of at least one kind of metal selected from the group consisting of: silver; and
gold.

8. The conductive composition according to claim 1, wherein the metal particle has a volume-based 50% cumulative particle diameter of 5 nm or more to 100 nm or less.

9. The conductive composition according to claim 1, further comprising an aqueous medium.

10. A method of producing the conductive composition of claim 1, the method comprising:
a first step of reducing a metal salt in an aqueous medium to form the metal particle; and
a second step of bringing the formed metal particle into contact with the treatment agent.

11. The method of producing the conductive composition according to claim 10, wherein the metal salt to be used is a recovered metal salt recovered from a metal waste liquid.

12. A method of recording a conductive image comprising a step of applying the conductive composition of claim 1 to a base material.

13. The method of recording a conductive image according to claim 12, wherein the step of applying the conductive composition to the base material is performed by an ink jet method.

14. The method of recording a conductive image according to claim 12, further comprising a step of drying the conductive composition applied to the base material at a temperature of 20° C. or more to 50° C. or less.

15. A conductive image comprising:
a base material; and
a conductive layer formed on the base material,
wherein the conductive layer contains:
a metal particle; and
a treatment agent for coating the metal particle, and
wherein the treatment agent is at least one kind selected from the group consisting of: a compound represented by the following general formula (1); a compound represented by the following general formula (2); a compound represented by the following general formula (3); a compound represented by the following general formula (4); a compound represented by the following general formula (5); a compound represented by the following general formula (6); and a compound represented by the following general formula (7): 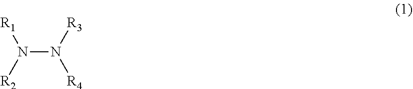
in the general formula (1), R₁ to R₄ each independently represent a hydrogen atom, an aliphatic group, an aromatic group, an acid ester group or a hydrophilic group, at least one of R₁ to R₄ represents the hydrophilic group, not all of the rest of R₁ to R₄ simultaneously represent hydrogen atoms and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond; 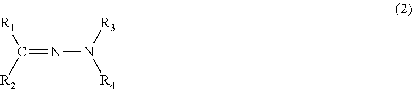
in the general formula (2), R₁ to R₄ each independently represent a hydrogen atom, an aliphatic group, an aromatic group, an acid ester group or a hydrophilic group, at least one of R₁ to R₄ represents the hydrophilic group, not all of the rest of R₁ to R₄ simultaneously represent hydrogen atoms and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond;
R₁—N═N—R₂ (3)
in the general formula (3), R₁ to R₂ each independently represent an aromatic group or a hydrophilic group, at least one of R₁ to R₂ represents the hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond;
R₁—N═N—NH—R₂ (4)
in the general formula (4), R₁ to R₂ each independently represent an aromatic group or a hydrophilic group, at least one of R₁ to R₂ represents the hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond;
R₁—CN (5)
in the general formula (5), R₁ represents a hydrophilic group and the hydrophilic group is: (i) a heteroaromatic group; (ii) an aromatic group to which at least one kind of hydrophilic functional group selected from the group consisting of: a hydroxy group; a carboxylic acid group; a sulfonic acid group; a phosphoric acid group; a phosphonic acid group; a tertiary alkylamino group; and a heteroaromatic group is bonded; or (iii) an aromatic group to which the hydrophilic functional group is bonded via an aliphatic group that may have a heteroatom, an amide bond or an ester bond; 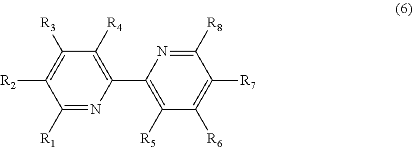
in the general formula (6), R₁ to R₈ each independently represent a hydrogen atom, an aliphatic group, an aromatic group, an acid ester group or a hydrophilic group, at least one of R₁ to R₈ represents the hydrophilic group and the hydrophilic group is: (i) any hydrophilic functional group selected from the group consisting of: a hydroxy group; a carboxylic acid group; a sulfonic acid group; a phosphoric acid group; a phosphonic acid group; a tertiary alkylamino group; and a heteroaromatic group; or (ii) an aliphatic group to which the hydrophilic functional group is bonded and which may have a heteroatom, an amide bond or an ester bond; and 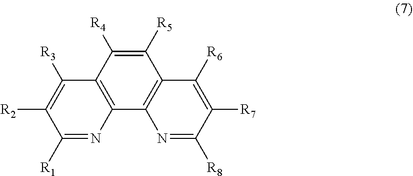
in the general formula (7), R₁ to R₈ each independently represent a hydrogen atom, an aliphatic group, an aromatic group, an acid ester group or a hydrophilic group, at least one of R₁ to R₈ represents the hydrophilic group and the hydrophilic group is: (i) any hydrophilic functional group selected from the group consisting of: a hydroxy group; a carboxylic acid group; a sulfonic acid group; a phosphoric acid group; a phosphonic acid group; a tertiary alkylamino group; and a heteroaromatic group; or (ii) an aliphatic group to which the hydrophilic functional group is bonded and which may have a heteroatom, an amide bond or an ester bond.

16. A conductive image to be recorded on a base material, wherein the conductive image is formed of the conductive composition of claim 1.

17. The conductive image according to claim 16, wherein the base material is glass, paper or a resin material.

18. The conductive image according to claim 17, wherein the resin material is a biocompatible material.

19. The conductive image according to claim 18, wherein the biocompatible material is at least one kind selected from the group consisting of: gelatin; cellulose; chitosan; collagen; and fibroin.
